(19) United States
(12) Patent Application Publication
(10) Pub. No.: US 2014/0033120 A1
(43) Pub. Date: Jan. 30, 2014

(54) SYSTEM AND METHODS FOR PRESENTING MARKET ANALYSES USING INTUITIVE INFORMATION PRESENTATION

(71) Applicants: David BENTAL, Encino, CA (US); Joel M. Antolini, Yarmouth, ME (US); Zinovii Dmytriv, Lviv (UA); Kenneth M. Klee, Piedmont, CA (US); Kenneth A. Koster, San Francisco, CA (US); Joseph U. Romaine, Philadelphia, PA (US); Matthew A. Schnitz, Pasadena, CA (US); Stephen E. Still, Vienna, VA (US)

(72) Inventors: David BENTAL, Encino, CA (US); Joel M. Antolini, Yarmouth, ME (US); Zinovii Dmytriv, Lviv (UA); Kenneth M. Klee, Piedmont, CA (US); Kenneth A. Koster, San Francisco, CA (US); Joseph U. Romaine, Philadelphia, PA (US); Matthew A. Schnitz, Pasadena, CA (US); Stephen E. Still, Vienna, VA (US)

(21) Appl. No.: 13/558,442

(22) Filed: Jul. 26, 2012

(51) Int. Cl. G06F 3/048

(52) U.S. Cl. 715/803

(57) ABSTRACT

Methods and apparatus for conducting market analyses on data drawn from various one or more sources for conducting airline travel and cargo market analyses and the presentation of analysis results using intuitive graphical user interfaces. Data is displayed in a visual dashboard having plural dashboard panes for interfacing an associated user with a plurality of associated databases. Data is presented to an associated user from at least one associated database in drill down enabled hierarchical levels. A user is presented with data from associated firewall protected and non-firewall protected databases in selectable merged visual formats.

### BACKGROUND

### Technical Field

The embodiments described herein relate to a system and methods for conducting market analyses on data drawn from various one or more sources and, more particularly, to method and system for conducting airline travel and cargo market analyses and the presentation of analysis results using intuitive graphical user interfaces. Although the example embodiments described herein are directed to the airline industry, it is to be appreciated that the embodiments are not so limited and have broader application to other industries such as, for example, trucking, rail, lodging, car rental, and maritime industries, to name a few examples.

Basic commercial tools are available for performing reviews on the data contained in databases. These tools, however, offer only generic one-size-fits-all functionality, so certain sophisticated analyses are often beyond the capabilities of these products. In addition, many database analysis tools are limited to interfacing with single sources of data and, further, many are limited in the manner in which the data may be presented.

In the airline industry, analysts often access databases containing U.S. Department of Transportation (U.S. DOT) data, databases containing Airlines Reporting Corporation (ARC) data, databases containing fleet data, databases containing International Air Transport Association (IATA) data, databases containing other external data sources, and their airline's own internal proprietary data. In addition, certain proprietary data contained in local databases may be relevant as well separate from, or in combination with, the internal proprietary data.

In the past, each of the U.S. DOT, ARC, IATA, fleet, other external, and internal proprietary databases were accessed individually and, accordingly, side by side comparisons were tedious and difficult. None of the data retrieved in accordance with desired search queries was presented in a convenient, intuitive, single-interface dashboard view.

Still further, none of the data retrieved in accordance with desired search queries was presented in a manner having drill-down functionality, wherein hierarchical levels of the data can be easily, quickly, and intuitively navigated in a single interface by the analyst.

Yet still further, none of the data retrieved in accordance with desired search queries enabled the merging of both internal proprietary as well as external non-proprietary data in a user interface.

Further, it has not been possible to easily and efficiently develop or analyze linkage data tying passenger ticket purchase data with passenger travel data for purposes of studying the habits of selected traveler sets. For certain traveler types such as frequent flyers, for example, an analysis of the associations between the travel plans of the frequent flyer against the actual travel results, executed in one or more travel segments, would be most useful to those in the industry.

### BRIEF SUMMARY

In accordance with an embodiment as embodied and broadly described herein, there is provided a method for accessing information from multiple database sources for interfacing an associated user with a plurality of associated databases by presenting data in a visual dashboard display having two or more dashboard panes. A representation of a first set of query results is retrieved from the plurality of associated databases in accordance with a first query and is displayed in a first visual pane. A representation of a second set of query results is retrieved from the plurality of associated databases in accordance with a second query using the first set of query results as parameters and is displayed in a second visual pane. A representation of a third set of query results is retrieved from the plurality of associated databases in accordance with a third query using at least one of the first set of query results or the second set of query results as parameters and is displayed in a third visual pane. A representation of a fourth set of query results is retrieved from the plurality of associated databases in accordance with a fourth query using at least one of the first set of query results, the second set of query results, or the third set of query results as parameters and is displayed in a fourth visual pane. User input is received to make a selection relative to the representations in the first visual pane of the first set of query results. Based on the selection of the user, each of the representations in the first visual pane, the second visual pane, the third visual pane, and the fourth visual pane is simultaneously updated.

In accordance with one embodiment as embodied and broadly described herein, there is provided a method for accessing information from multiple database sources for interfacing an associated user with a plurality of associated databases by presenting data in a visual dashboard display having two or more dashboard panes. A representation of a first set of travel origination locations and a first set of travel destination locations is retrieved from a plurality of associated databases and is displayed in a visual map pane of a user interface. A representation of a set of quantities of passengers carried during a selected focus time period from selected ones of the first set of travel origination locations to selected ones of the first set of travel destination locations is displayed in a passengers serviced pane of the user interface. A representation of a set of fares paid by the passengers carried during the selected focus time period from the selected ones of the first set of travel origination locations to the selected ones of the first set of travel destination locations is displayed in a fare paid pane of the user interface. A representation of revenues collected for travel during a selected gross time period from the selected ones of the first set of travel origination locations to the selected ones of the first set of travel destination locations is displayed in a revenue pane of the user interface, wherein at least a portion of the graphical representation of revenues comprises a product of the set of quantities of passengers and the set of fares paid by the passengers during the selected focus time period. A user input is received to select representations in the visual map pane of the first sets of travel origination and destination locations is received. Each of the representations in the visual map pane, the passengers serviced pane, the fare paid pane, and the revenue pane is simultaneously updated based on the selection of the user input.

In accordance with yet another embodiment as embodied and broadly described herein, there is provided a method for presenting data in a visual dashboard display having plural user-selectable graphical dashboard panes for interfacing an associated user with an associated database. At least a first and second query selections are received. The first and second queries are executed to selectively retrieve first and second result data from the associated database in accordance with the first and second query selections. First and second query result presentations are received including data specifying first and second graphical presentation styles. Displays are generated for displaying the first and second result data in the first and second graphical presentation styles in accordance with the first and second query results presentations, respectively.

In one embodiment, at least a third query selection is received and the third query is executed to retrieve result data from the associated database in accordance with the query selection. A third query result presentation is received including data specifying a graphical presentation style. A display is generated for displaying the first, second, and third result data in the first, second, and third graphical presentation styles. In yet another embodiment, at least a fourth query selection is received and the fourth query is executed to retrieve result data from the associated database in accordance with the query selection. A fourth query result presentation is received including data specifying a graphical presentation style. A display is generated for displaying the first, second, third, and fourth result data in the first, second, third, and fourth graphical presentation styles.

In the example embodiments, the graphical presentation styles include for example at least one of a graphical map, a graphical heat map, a graphical chart, a bar graph, a standard chart, a line chart, a line and bar chart, a pie chart, a bubble chart, a plot chart, a stacked bar chart, a histogram chart, an area chart, a point heat map, and a chart map.

In accordance with yet another embodiment as embodied and broadly described herein, there is provided a method for accessing information from multiple database sources, using a computer executing one or more operations, for interfacing an associated user with a plurality of associated databases by presenting data to an associated user from the associated databases in selectable merged visual formats. A dialog box configured to receive, from the associated user, a first input query parameter. The associated first database is queried in accordance with the first input query parameter to retrieve a first set of data. The associated second database is queried in accordance with the first input query parameter to retrieve a second set data. The first set of data is merged with the second set data as query result data, wherein the query result data comprises data from the first database and data from the second database. A first selected portion of the query result data is displayed in a report display section of the user interface.

In accordance with yet another embodiment as embodied and broadly described herein, there is provided a method for accessing information from multiple remote firewall protected and non-firewall protected database sources, using a computer executing one or more operations, for interfacing an associated user with a plurality of associated databases by presenting protected and non-protected data to an associated user from the associated databases in selectable merged visual formats. A dialog box configured to receive, from the associated user, a first input query parameter. The associated firewall protected database is queried in accordance with the first input query parameter to retrieve a first set of proprietary non-published data. In one embodiment, the proprietary non-published data may be IATA data, ARC data, data from Innovata, fleet data, other externally created data, or the airline's own internal data for example. The associated non-firewall protected database is queried in accordance with the first input query parameter to retrieve a first set of non-proprietary published data. In one embodiment, the non-proprietary published data may be DOT data, for example. The first set of proprietary non-published data is merged with the first set of non-proprietary published data as query result data, wherein the query result data comprises at least one proprietary non-published data and at least one non-proprietary published data. A first selected portion of the query result data is displayed in a report display section of the user interface.

In accordance with another embodiment as embodied and broadly described herein, there is provided a method for accessing information, such as frequent flier information, from multiple database sources, using a computer executing one or more operations, for interfacing an associated user with a plurality of associated databases by presenting data to an associated user from at least one associated database in drill-down-enabled hierarchical levels. A representation of a first set of travel origination regions and a representation of a first set of travel destination regions is displayed in a query data parameter portion of a user interface. A selection of a first travel origination region from among the first set of travel origination regions and a selection of a first travel destination region from among the first set of travel destination regions is received from the associated user. A query is generated based on the selected first travel origination and destination regions, and first data is retrieved from the associated database in accordance with the query. A first portion of the first data retrieved is displayed as first level results in a first level result presentation portion of the user interface. A drill-down selection of a one of the first level results is received from the associated user. A second portion of the first data, used to generate the selected one of the first level results, is identified. The second portion of the first data is displayed as second level results in a second level result presentation portion of the user interface.

It is to be appreciated that the foregoing general descriptions and the following detailed descriptions are exemplary and explanatory only, and merely provide further explanation of the claimed embodiments.

### BRIEF DESCRIPTION OF THE DRAWINGS

FIG. 1 is a schematic block diagram of a computer architecture suitable for use with the example embodiments described herein;

FIG. 2 is a block diagram of components of an intuitive graphical user interface system in accordance with the example embodiments;

FIG. 3 is a view of a dynamic graphical user interface in accordance with an example embodiment;

FIGS. 4a-4c are views of a dynamic graphical user interface in accordance with an example embodiment;

FIGS. 5a-5c are views of a dynamic graphical user interface in accordance with an example embodiment;

FIG. 6 is a flow chart illustrating a method generating the interfaces of FIGS. 4 and 5 in accordance with the example embodiments;

FIGS. 7a-7j are graphical illustrations of user-selectable graphical dashboard panes for querying and presenting data in accordance with user-selectable preferences in accordance with an example embodiment; and,

FIG. 8 is a flow chart illustrating a method generating the interfaces and reports of FIGS. 7a-7j in accordance with the example embodiment.

FIG. 9 is a view of a dynamic graphical user interface in accordance with an example embodiment;

FIG. 10 is a flow chart illustrating a method generating the interface of FIG. 9 in accordance with the example embodiments;

FIGS. 11a-11c are views of a dynamic graphical user interface for generating reports for intuitive analysis of internal frequent flyer travel data in accordance with an example embodiment;

FIG. 12 is a flow chart illustrating a method generating the interfaces and reports of FIGS. 11a-11c in accordance with the example embodiment;

### DETAILED DESCRIPTION OF THE EMBODIMENTS

The subject application is directed to a system and methods for conducting market analyses and presenting the analyses results using intuitive graphical interfaces. In particular, the subject application is directed to a system and methods for conducting airline travel and cargo market analyses. The system and methods of the subject application suitably provide an intuitive and convenient user interface allowing a user to easily select parameters for which to perform market analyses. The system and methods generate intuitive dynamic reports which allow a user to easily and quickly interpret the results and to make adjustments to the parameters based on the results.

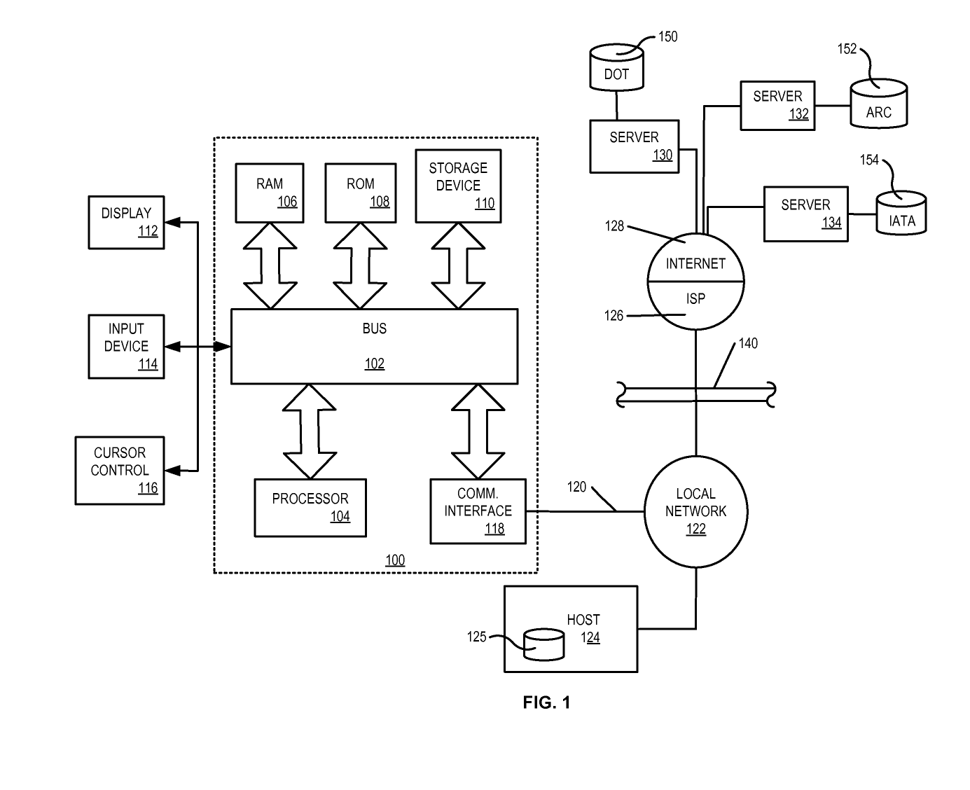

FIG. 1 is a block diagram that illustrates a computer system 100 suitable for executing embodiments of one or more software systems or modules that perform market analyses according to the subject application. The example system includes a bus 102 or other communication mechanism for communicating information, and a processor 104 coupled with the bus for processing information. The computer system includes a main memory, such as random access memory (RAM) 106 or other dynamic storage device for storing information and instructions to be executed by the processor 104, and read only memory (ROM) 108 or other static storage device for storing static information and instructions for the processor 104. A storage device 110 is also suitably provided for storing information and instructions.

The example embodiments described herein are related to the use of the computer system 100 for accessing, aggregating, manipulating and displaying information from multiple remote resources such as, for example, from multiple public and private commercial subscription-based airline industry data sources such as, for example, U.S. Department of Transportation (DOT) data sources, International Air Transport Association (IATA) data sources, and the like. Further, the embodiments described herein are related to the use of computer system 100 for accessing information from the multiple public and commercial airline industry data sources in selective combination with internal proprietary data such as sales, costs, expense records, travel agency data, and frequent flyer data from within a firewall 140. According to one implementation, information from the multiple remote public, commercial, and/or internal proprietary resources is provided by computer system 100 in response to the processor 104 executing one or more sequences of one or more instructions contained in main memory 106. Such instructions may be read into main memory 106 from another computer-readable medium, such as storage device 110. Execution of the sequences of instructions contained in main memory 106 causes the processor 104 to perform the process steps described herein. In an alternative implementation, hard-wired circuitry may be used in place of or in combination with software instructions to implement the invention. Thus implementations of the example embodiments are not limited to any specific combination of hardware circuitry and software.

In accordance with the descriptions herein, the term “computer-readable medium” as used herein refers to any media that participates in providing instructions to the processor 104 for execution. Such a medium may take many forms, including but not limited to volatile and non-volatile media. Non-volatile media includes, for example, optical or magnetic disks. Volatile media includes dynamic memory for example and does not include transitory signals, carrier waves, or the like. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, or any other tangible non-transitory medium from which a computer can read.

The computer system 100 includes a communication interface 118 coupled to the bus 102 which provides a two-way data communication coupling to a network link 120 that is connected to local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 supporting a database 125 storing internal proprietary data and/or to data equipment operated by an Internet Service Provider (ISP) 126. ISP 126 in turn provides data communication services through the Internet 128. Local network 122 and Internet 128 both use electric, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet-connected example embodiment, the system 100 is operatively connected with a plurality of external public, private, governmental or commercial servers 130, 132, 134. In the example embodiment shown, the first server 130 is coupled with a database 150 storing U.S. DOT data, the second first server 132 is coupled with a database 152 storing Airlines Reporting Corporation (ARC) data, and the third server 134 is coupled with a database 154 storing International Air Transport Association (IATA) data. The computer system 100 is operative to selectively transmit a request for data to be selectively retrieved from the respective databases 150, 152, 154 through Internet 128, ISP 126, local network 122 and communication interface 118 or to receive selected data pushed from the databases 150, 152, 154, or by both means in accordance with the example embodiments. The received data is processed executed by the processor 104 as it is received, and/or stored in storage device 110, or other non-volatile storage for later processing or data manipulation.

Although computer system 100 is shown in FIG. 1 as being connectable to a set of three (3) servers, 130, 132, and 134, those skilled in the art will recognize that computer system 100 may establish connections to multiple additional servers on Internet 128. Each such server in the example embodiments includes HTTP-based Internet applications, which may provide information to computer system 100 upon request in a manner consistent with the present embodiments. Additionally, for purposes of this description host 124 comprises a legacy computer accounting application.

It is to be appreciated that although the U.S. DOT data as well as the ARC and IATA data were described above as residing on the external databases 130, 132, 134, the data may be selectively copied or otherwise transferred to one or more designated portions of the user's local system database 125. For example the data may be copied in accordance with a predetermined schedule such as, for example, every day, week or month. In accordance with an embodiment, the US DOT, ARC, and/or IATA data may be selectively copied into the user's local system database 125 as necessary or desired by the user invoking any suitable commands to retrieve the data.

Selectively locating the public, governmental and commercial data within the firewall 140 is advantageous for numerous reasons including enabling rapid comprehensive local queries without substantial network overhead. However, it is important to maintain the accuracy of the data by performing update or refresh operations on a schedule based on the characteristics of the desired data or on the data requirements of a particular query.

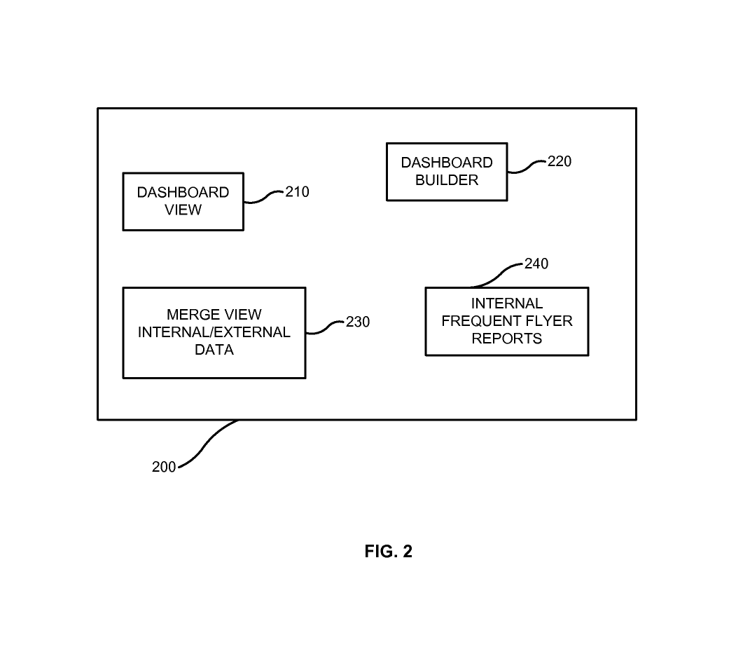

The computer system 100 suitably includes several subsystems or modules to perform the market analyses as set forth herein. A primary purpose of the subject application is to provide an improved intuitive and convenient user interface which allows a user to select parameters for performing market analyses, and to generate intuitive dynamic reports which allow the user to quickly interpret the market analysis results and to make adjustments of the parameters based on the result presentation as necessary or desired. FIG. 2 illustrates the computer system 100 as shown in FIG. 1 and includes selected modules in accordance with an example embodiment. To the above end, the computer system includes a dashboard module 210 which is configured in accordance with the example embodiments to present information on the display 112 in unique multiple frames. The dashboard module 210 uses information retrieved from the one or more databases in accordance with one or more search queries, and displays the information in one or more frames in one or more intuitive formats that are easy to understand such as for example, in graphical, chart, map, or other form. The dashboard module 210 separates a display screen into multiple frames to display information from multiple sources such as, for example, from one or more of the external databases DOT 150, ARC 152, IATA 154, from the internal database 125, or from selected combinations of the external databases and the internal database 125. In a further example embodiment, the dashboard module 210 is configured to use information, such as passenger information, from one or more first frames, such as a passenger frame and a fare frame, on the display and manipulate the information for unique one or more presentations on one or more other display frames, such as a display of revenue information on a revenue frame, on the display 112. It is understood, however, that the dashboard module includes the functionality to display any number of frames, such as one, two, ten, and the like.

The computer system further includes a dashboard builder tool module 220 which is configured to provide users of the system with the ability to create unique customized search queries as well as unique customized search result presentation formats. The query and presentation formats are selectively saved in a memory 106, 110 of the system 200 for re-use during subsequent queries for analyzing the data in accordance with the needs or requirements of the user.

The computer system further includes a merge module 230 configured to provide the users of the system with convenient and unique views of all of the data available to the system, including the ability to view proprietary internal data, such as, for example, the internal data of database 125, as well as the ability to view non-proprietary public, governmental or private commercial data such as, for example, the DOT data of database 150, ARC data of database 152, and IATA data of database 154. In the example embodiment, other views are provided as well, including the ability to view the DOT data together with the ARC and IATA data, and in combination with the user's proprietary data contained in the internal database 125.

The computer system further includes an internal frequent flyer data report module 240 which is configured to receive user input for querying the system in connection with selected aspects of frequent flyer and travel agency data.

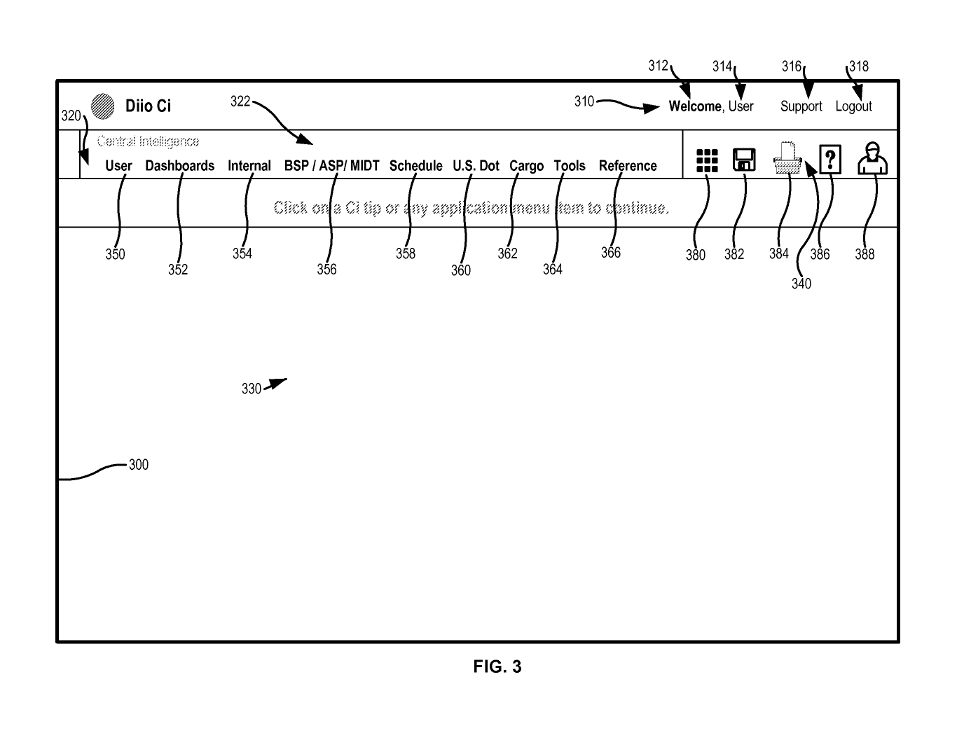

FIG. 3 shows a graphical user interface 300 in accordance with an embodiment. In general, the interface is divided into distinct sections for use in performing airline industry analyses. A dialog section 310 shown in the example embodiment in the upper right hand corner of the interface 300 is configured to enable the system to display a welcome message 312 including an identification 314 of the user logged-into the system, as well as the support link 316 and an active log out 318. A market analyses task selection section 320 includes a plurality of interface tabs 322 configured to enable the user to select various functions provided by the system 100, the results of which are graphically presented to the user in a market analyses results display section 330. In the example embodiment illustrated, the interface tabs include a User tab 350, a Dashboard tab 352, an Internal tab 354, a BSP/ASP/MIDT tab 356, a Schedule tab 358, a USDOT tab 360, a Cargo tab 362, a Tools tab 364 and a Reference tab 366. The functions of selected tabs 350-366 will be described below in greater detail with referenced to the example embodiments.

Lastly with reference to FIG. 3, a tools section 340 is configured to provide access to users of the system to selected tools including a site map presentation or view by a site map button 380. Search results may be saved to disk or elsewhere by a save file button 382, and the results may be outputted to hard copy form by use of print button 384. Assistance is provided to users by a help button 386 and communities of users may share and exchange ideas relating to the system, to the airlines industry, or to market analyses performed on industry information in general by use of a forum button 388.

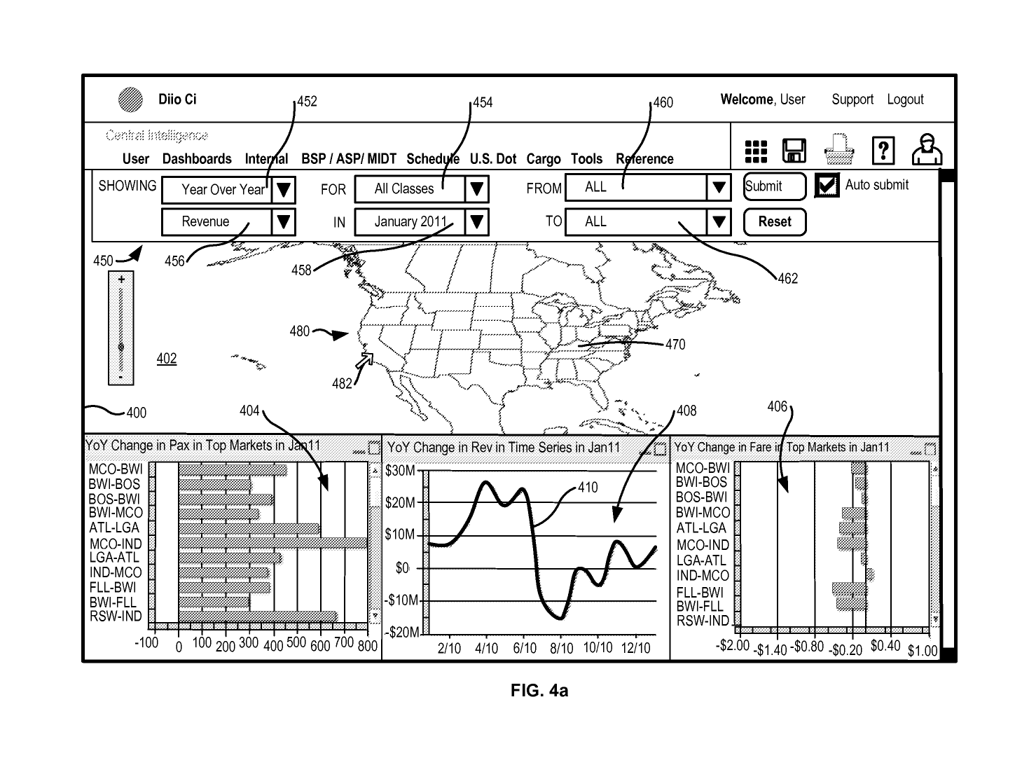

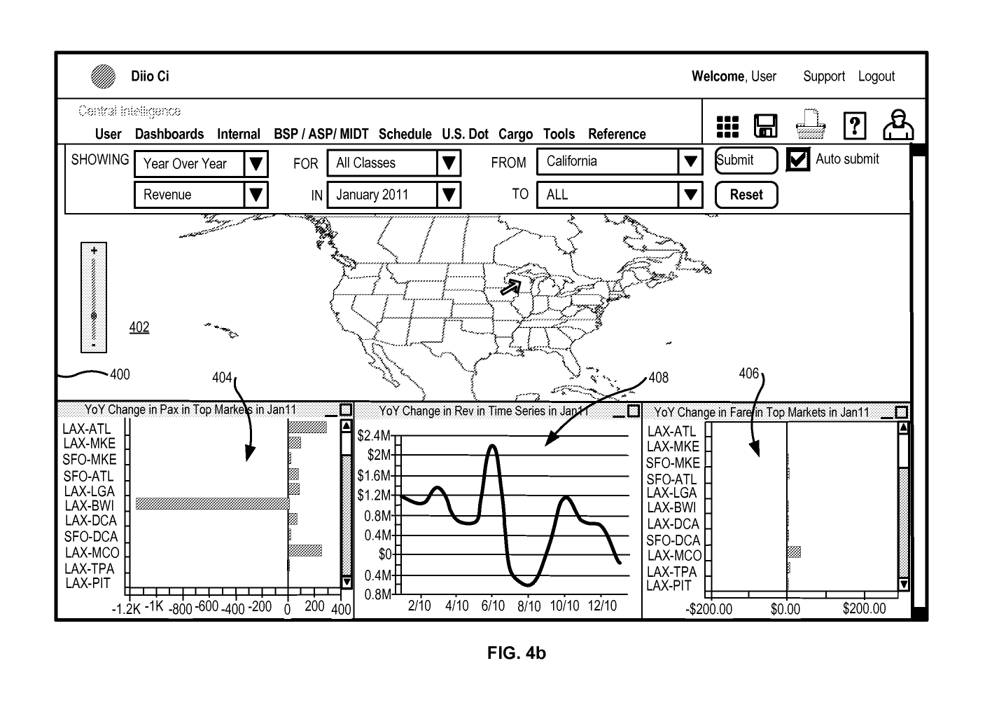

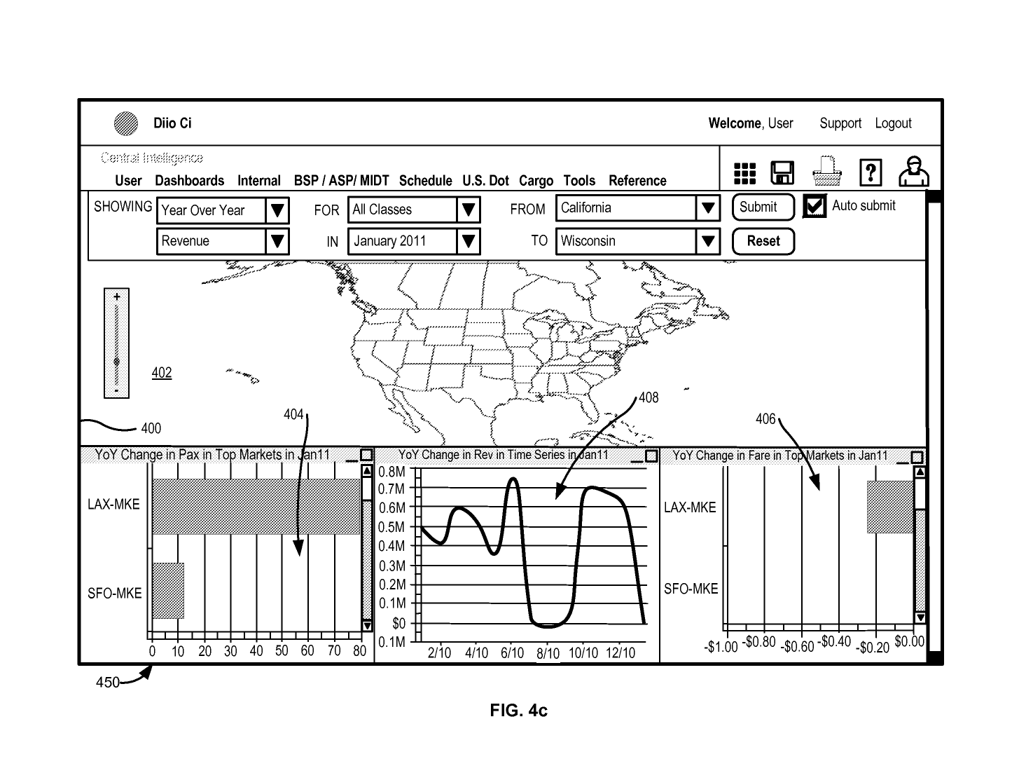

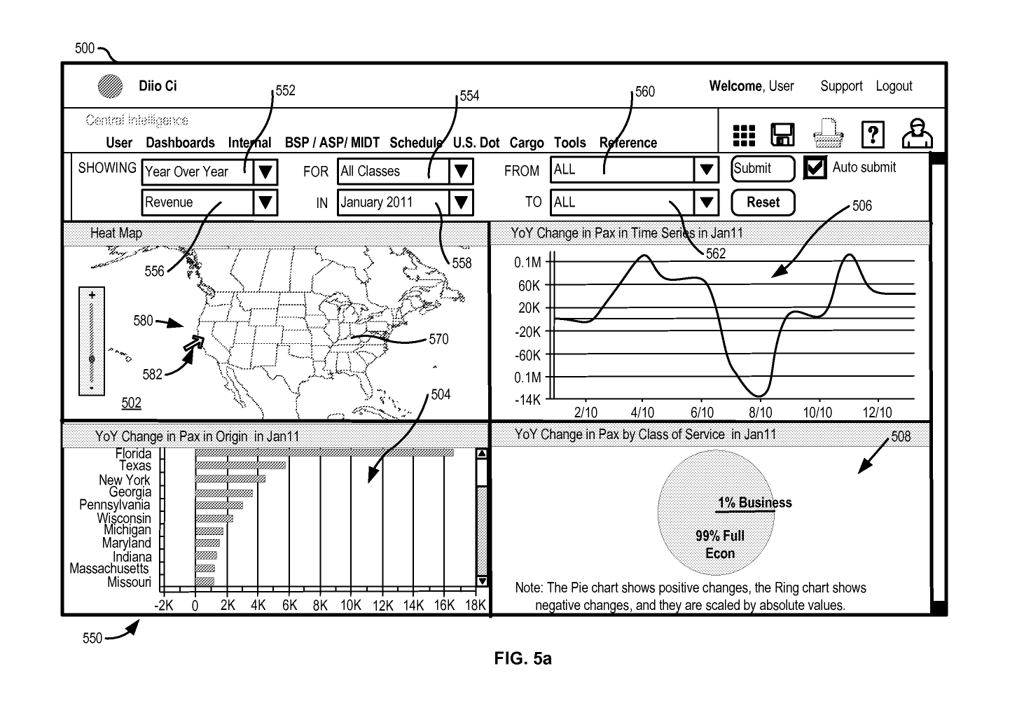

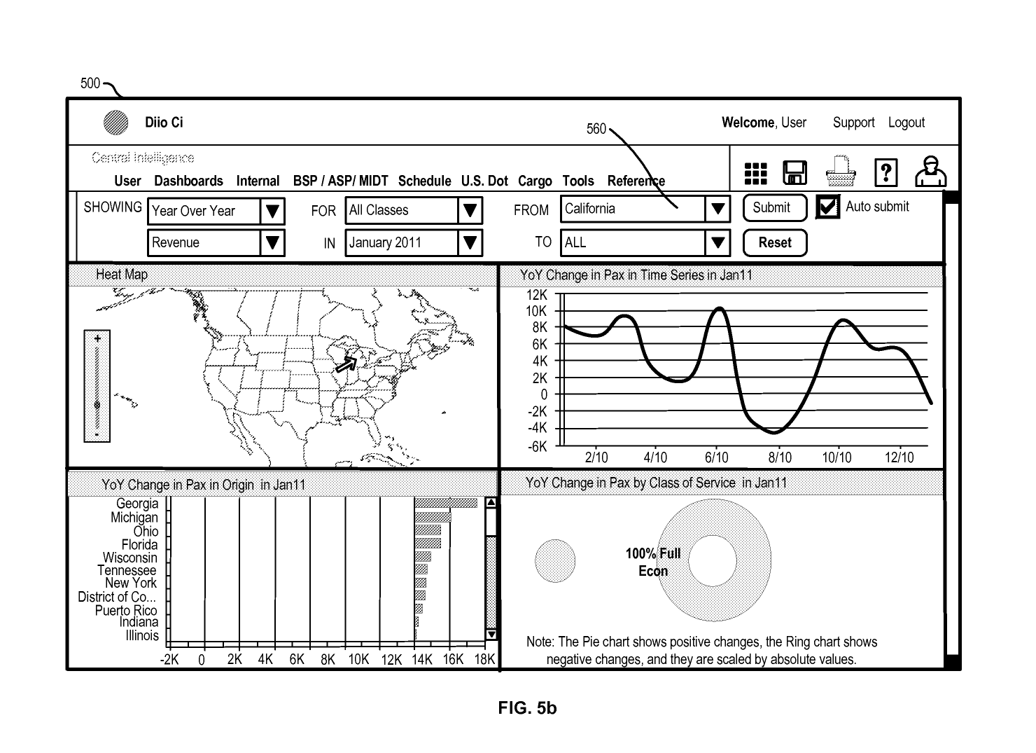

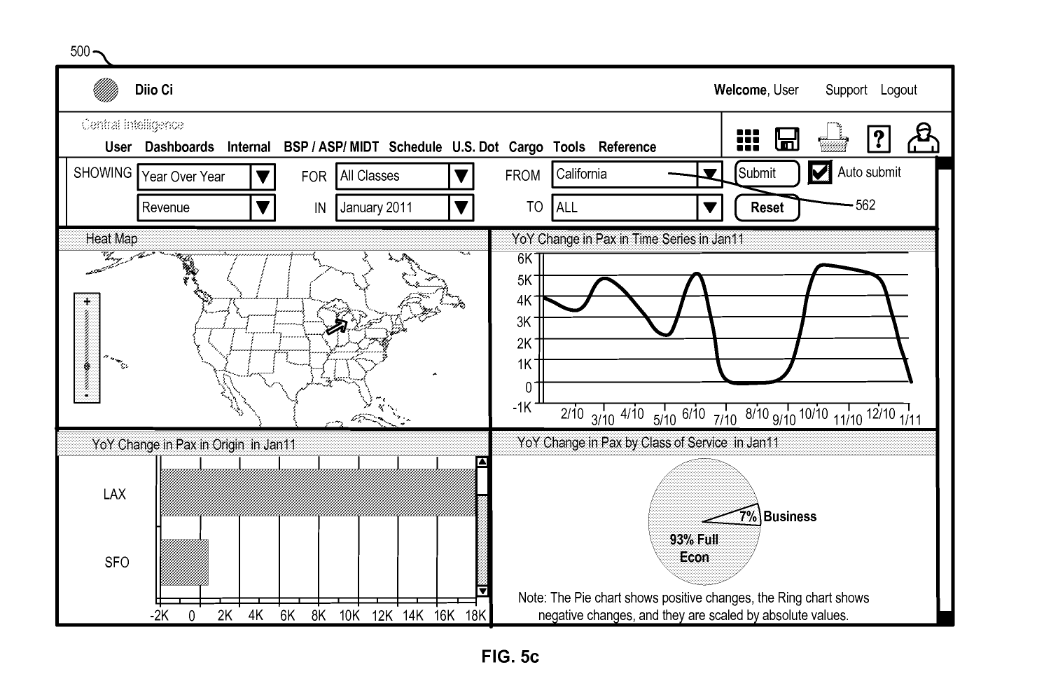

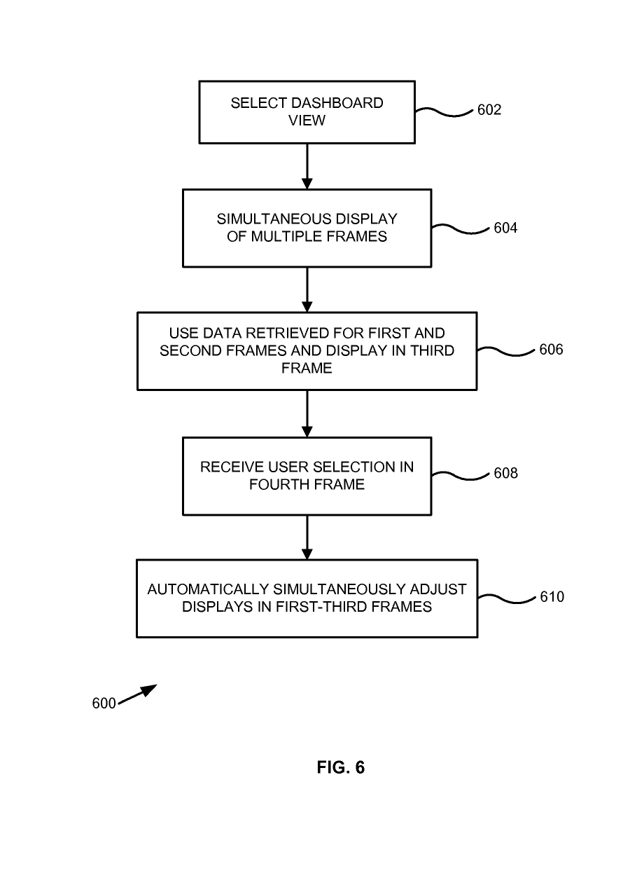

The functioning of the dashboard module is shown with reference to FIGS. 4-6. As shown in FIG. 6, at 602, a user selects the Dashboards tab 352, which invokes the dashboard view module 210 wherein, selectively, a revenue-based dashboard graphical interface 400 (FIGS. 4a-c) or a flight segments-based dashboard graphical interface 500 (FIGS. 5a-c) is presented to the user. In the example embodiment, multiple frames are simultaneously displayed 604 including, for example, a set of four (4) interface view panes including a visual map pane 402, a passengers pane 404, a fare pane 406, and revenue pane 408. As shown in FIG. 4, the passenger pane 404 illustrates the change in passengers year over year and the fare pane 406 represents the change in average fare year over year. It is to be appreciated that the revenue pane 408 presents a graph 410 of the change in revenues year over year in accordance with the data contained in the passengers pane 404 and the fare pane 406. That is, the revenue pane 408 is, essentially, a graphical representation of a product of the data presented in the passengers pane 404 and in the fare pane 406. It is understood that the passenger pane 404 and the fare pane 406 suitably illustrate other data related to passengers and to fares, such as the total number of passengers in a year and the average fare for the year. As such, the revenue pane 408 would present a graph of the revenues for the selected period in accordance with the data contained in the passenger pane 404 and the fare pane 406.

As shown in FIG. 6, multiple frames are simultaneously displayed at 604. In addition, the data retrieved for presentation of the first and second frames on the display is used as shown at 606 for a unique presentation in a third frame. For example, the data retrieved for the graphical presentation of the passengers pane 404 and for the graphical presentation of the fare pane 406 is collected, manipulated, and displayed in a unique graphical presentation in the revenue pane 408. In addition, it is to be appreciated that the data presented in the passengers pane 404 and the fare pane 406 is based on search query parameters obtained from the user by selection from the visual map pane 402 or from a search query dialog portion 450. It is to be further appreciated that the data in the various panes may be selectively displayed in various graphical formats in accordance with a selection from the user. For example, the passenger and fare data is presented in a graphical bar graph format, and the revenue data is presented in a line graph format. In accordance with the example embodiment, the system is configured to display the data in various other formats as will be described below including, for example, a heat map format.

The search query dialog portion 450 includes a report time period drop down selection box 452 for selecting a time period of the results displayed in the passengers pane 404 and the fare pane 406. In the illustrated example, the time period is selected as “year over year.” A ticket type drop down selection box 454 is configured to receive input from a user for selection of ticket type, such as defined by IATA resolution 728, which includes first class, business class, full economy, discount economy, and other classes. In the illustrated example, the ticket type drop down selection box 454 is selecting “all classes.”

It is to be understood that the fare data represents the average fare paid by a class of passengers. For example, if the query is for all classes of ticket, then the fare data represents the average fare paid by all passengers in the market. If the query is for first class tickets, then the fare data represents the average fare paid by all first class passengers in the market.

A report basis drop down selection box 456 is configured to receive user input for selecting a basis of the reports generated in the displays including the passengers pane 404 and the fare pane 406. In the example embodiments illustrated in FIGS. 4a-4c, the report basis selection is “revenue” and, further, in the example embodiment of FIGS. 5a-c, the report basis selection is “passengers.”

A report start date drop down selection box 458 is configured to receive user input for selecting a start date of the reports generated in the passengers pane 404 and the fare pane 406. In the example embodiment illustrated, the report start data is set to “January 2011.” A travel segment origination drop down selection box 460 is configured to receive user input with regard to data obtained from the one or more data basis in connection with passenger and cargo flights originating at a selected place. In the embodiment illustrated, the travel segment origination selection is “all.” Similarly, a travel segment destination drop down selection box 462 is configured to receive user input in connection with various selected passenger and cargo flight destination places. In the illustrated example, the original destination selection is “all.”

As shown in FIG. 4a and with reference to FIG. 6, the visual map pane 402 comprises a graphical representation of “all” travel segment origination places as well as a visual representation of “all” travel segment destination places in the form of a map 470 of North America. Input means 480 in the form of a location of a cursor 482 together with one or more of the input device 114 and the cursor control 116 is used by the system 100 to receive as shown at 608 (FIG. 6) a user selection in the visual map pane 402 of a travel segment origination selection 460. In operation, the user may use the input device 114 or any other form course control 116 to locate the courser 482 at a selected travel segment origination place. FIG. 4a shows the travel segment origination place as being selected as California. The system is responsive to the user input such as by clicking the mouse while it is disposed in a relative selected position on the visual map pane 402 to select California as the travel segment origination place. The user may also select the travel segment origination by selecting the origination from a drop down box selection box 460. As shown at 610 in FIG. 6, responsive to the user selection, the system automatically simultaneously adjusts or otherwise updates the displays presented in all of the relevant view panes including the map pane 402, the passengers pane 404, fare pane 406 and the combination thereof in the revenue pane 408 such as, for example, shown in FIG. 4b. It is to be appreciated that, in addition to simultaneously automatically adjusting the displays in the various other panes, the travel segment origination drop down selection box 460 is automatically adjusted to reflect the selection of the user using the input means 480. Similarly, additional user input is received such as shown, for example, in FIG. 4b wherein the user manipulates the input means 480 to hover on Wisconsin as shown. The system receives the user selection whereupon automatic simultaneous adjustment is made in the other view panes FIG. 4c including the map pane 402, the passengers pane 404, the fare pane 406, and the revenue pane 408. As shown, the travel segment destination drop down selection box 462 is also responsive to the user selection wherein, as can be seen, the destination place is selected and displayed as “Wisconsin,” and wherein the map pane, 402, the passengers pane 404, and the fare pane 406 are also updated to reflect the Wisconsin airport “MKE,” Milwaukee.

FIG. 5a-5c illustrate further embodiments wherein, as noted above, the dashboard view module 210 includes a dashboard graphical interface 500. In the example embodiment, the dashboard graphical interface 500 is presented in accordance with a flight segments-based data query protocol. With reference to those figures and with continued referenced to FIG. 6, the flights segments-based dashboard graphical interface 500 includes multiple frames which are simultaneously displayed as shown at 604 including, for example, a visual map pane 502, a passengers by origination pane 504, a passengers in time series pane 506, and a passengers by ticket classification pane 508.

As shown in FIG. 6, user selection is received shown at 608 in the visual map pane 402 such as, for example, by input means 580 in the form of the cursor 582. As shown, the cursor 582 is disposed at a travel segment origination place relative to the map, mainly California. The input device 114 receives the input and automatically simultaneously adjusts displays in the other view panes as shown at 610. More particularly, as shown in FIG. 5b, the travel segment origination place of “California” is received in FIG. 5a and the various panes 502-508 are simultaneously adjusted such as shown in FIG. 5b to reflect a new travel segment origination place or “California” in the drop down selection box 560. Further data manipulation is accomplished by receiving further user selection in the visual map pane 502 such as, for example, by hovering the cursor 582 adjacent to Wisconsin in the map. Input is received from the user whereupon the system automatically simultaneously adjusts as shown at 610 the displays in the various view panes including, for example, the passenger origination pane 504, the passenger in time series pane 506, and the passenger classification pane in accordance with the user selection.

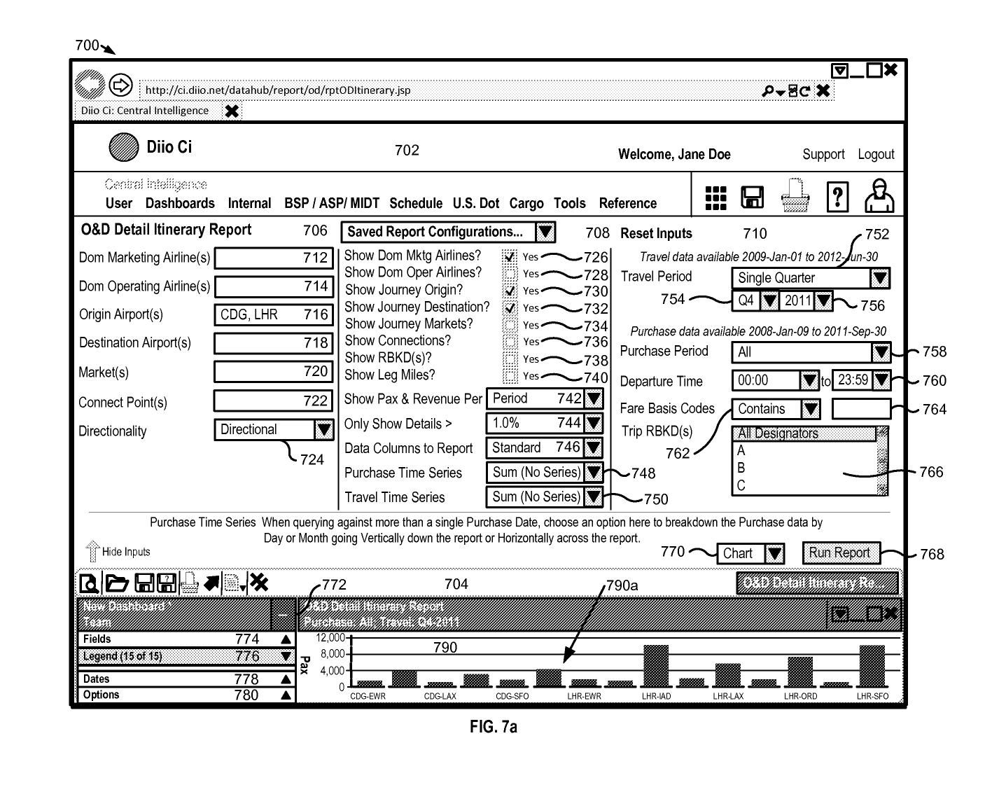

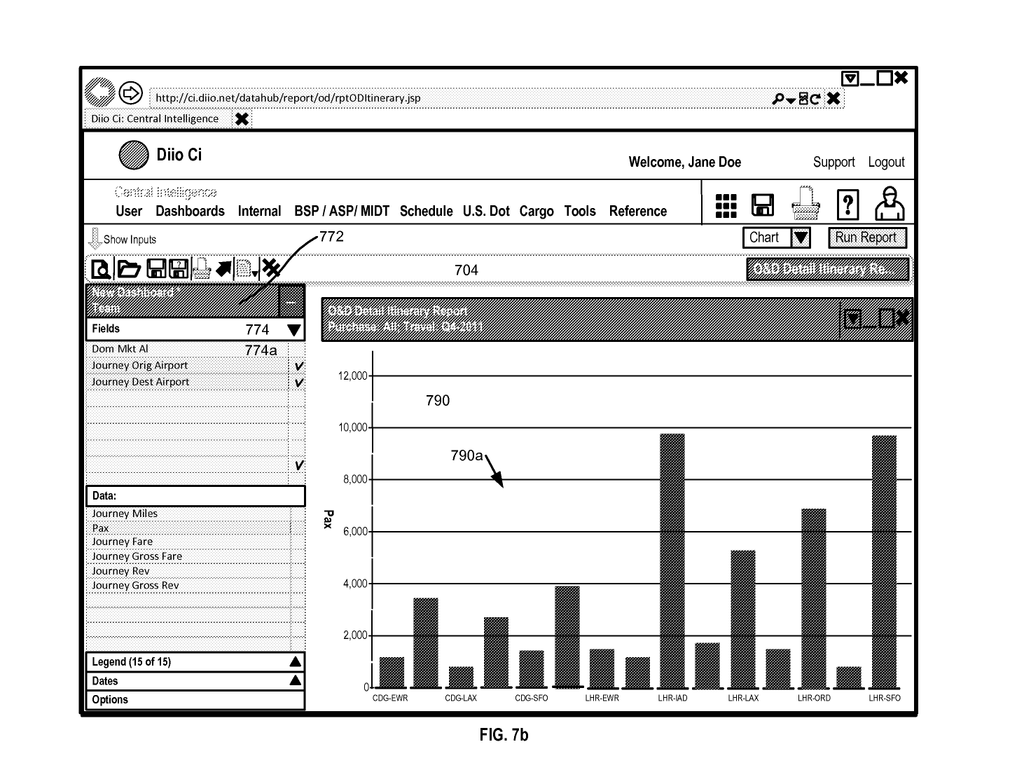

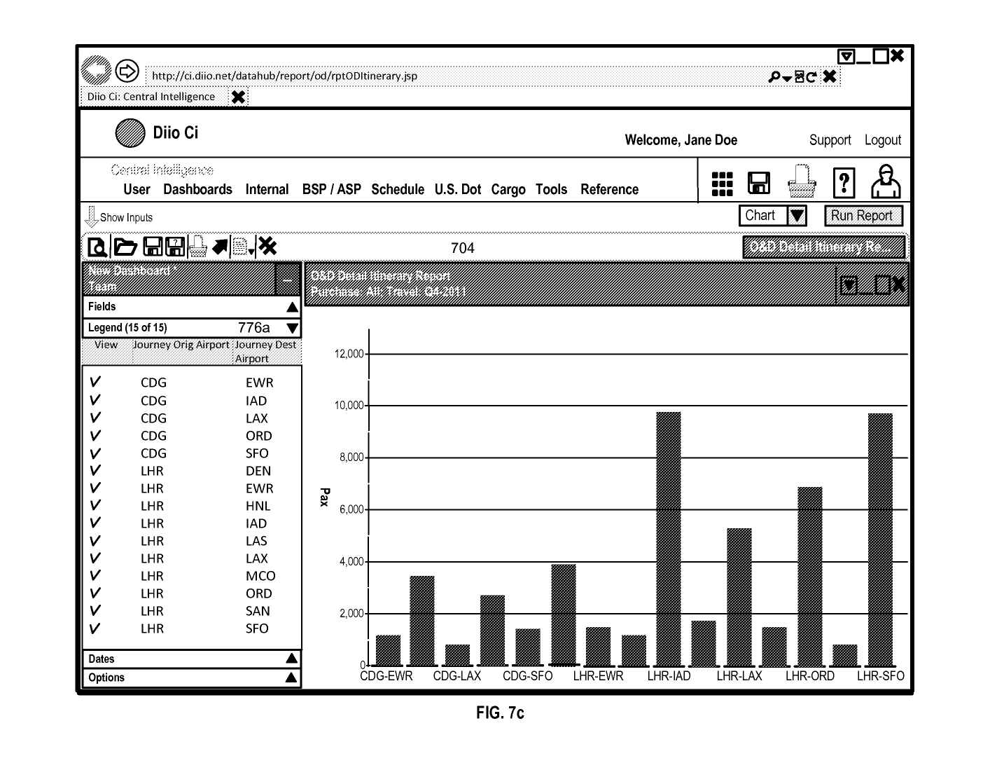

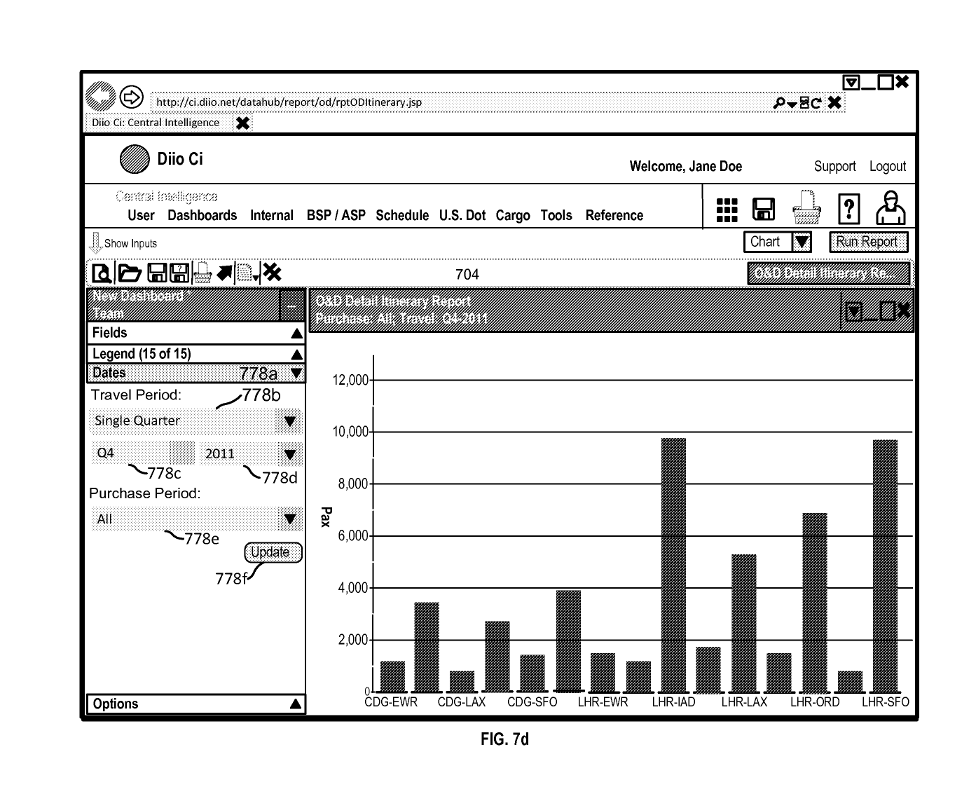

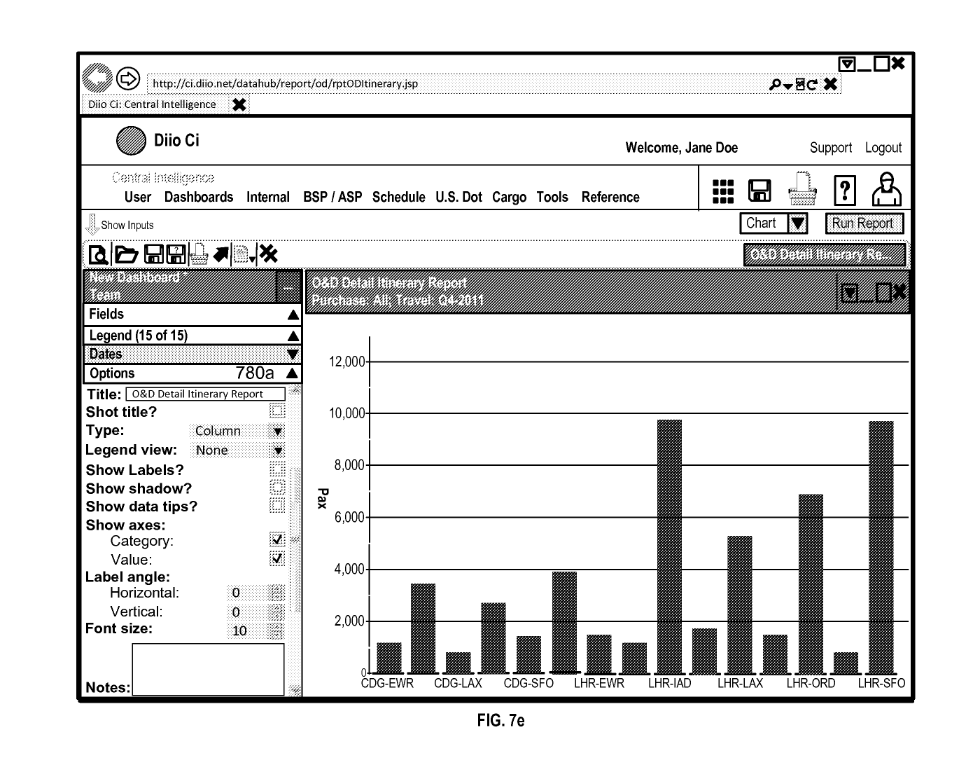

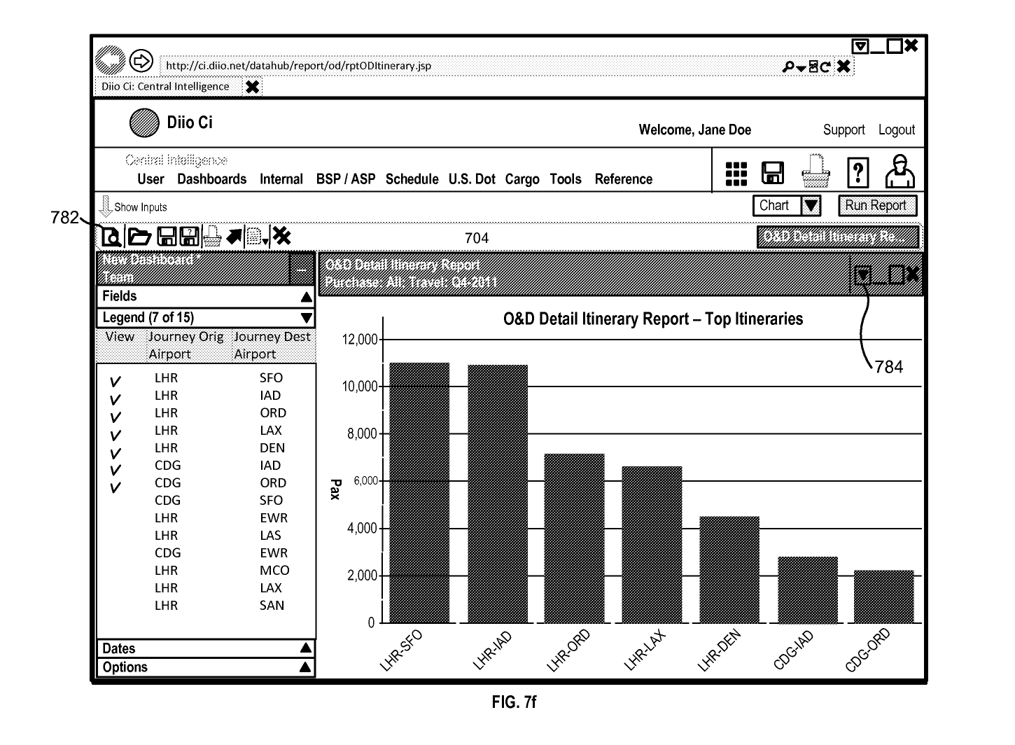

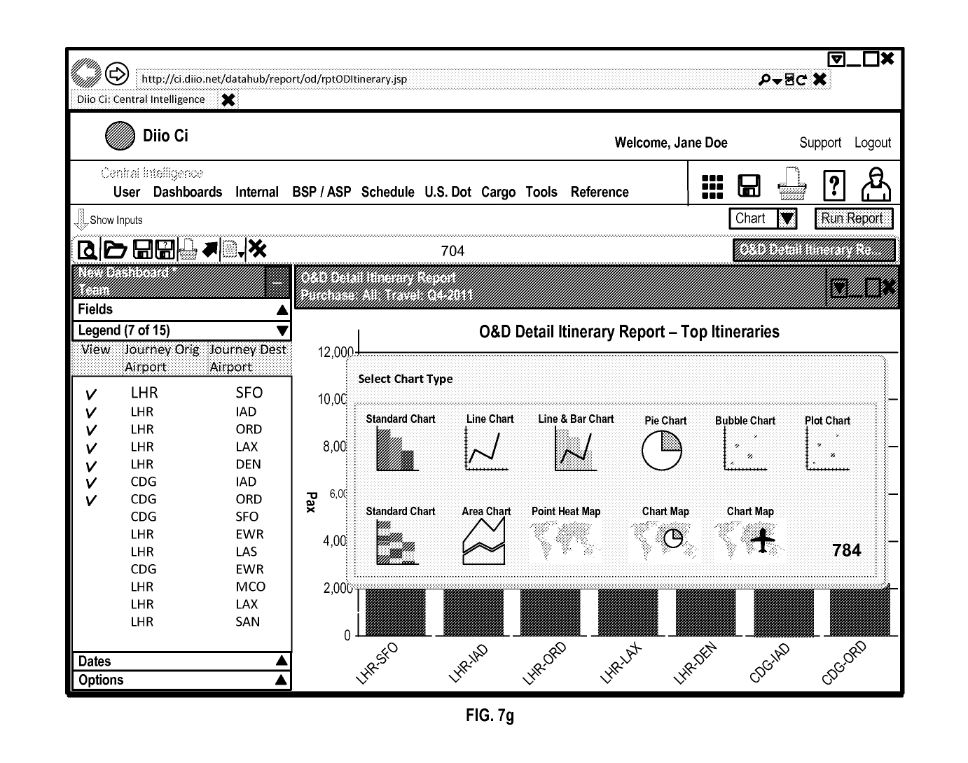

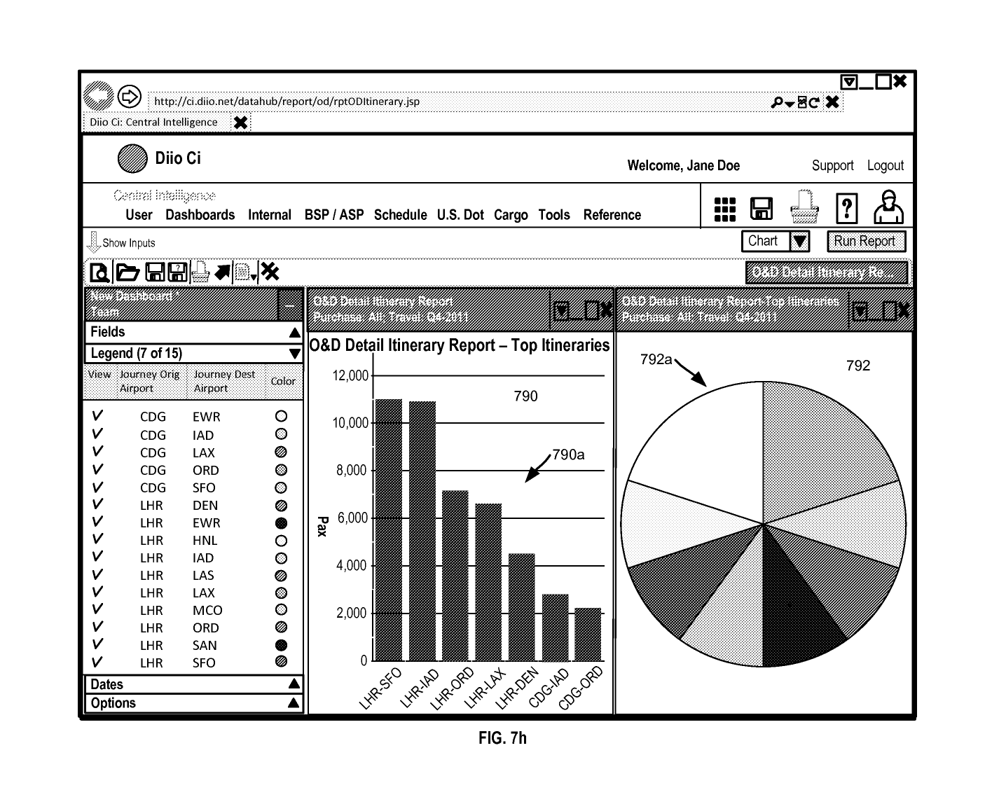

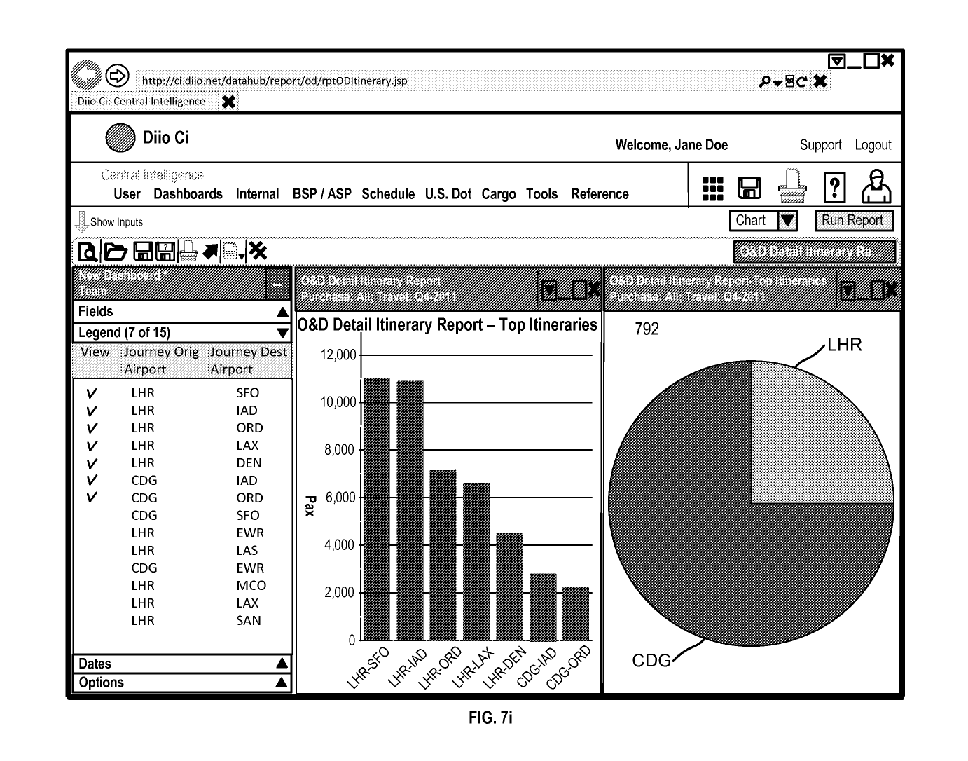

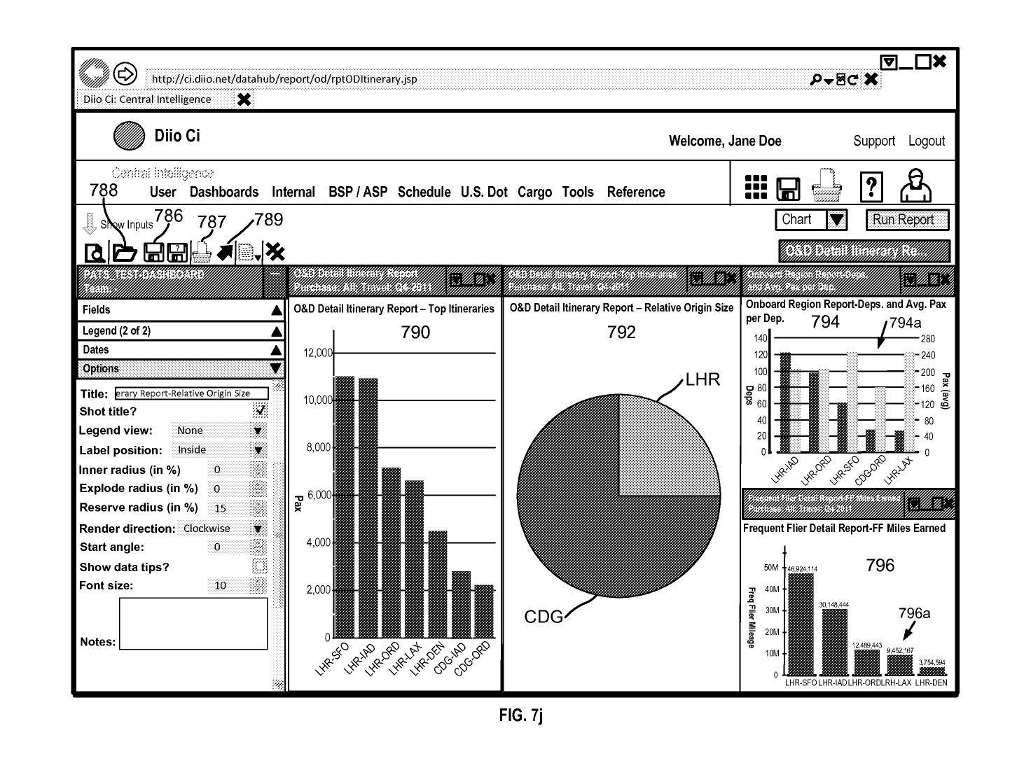

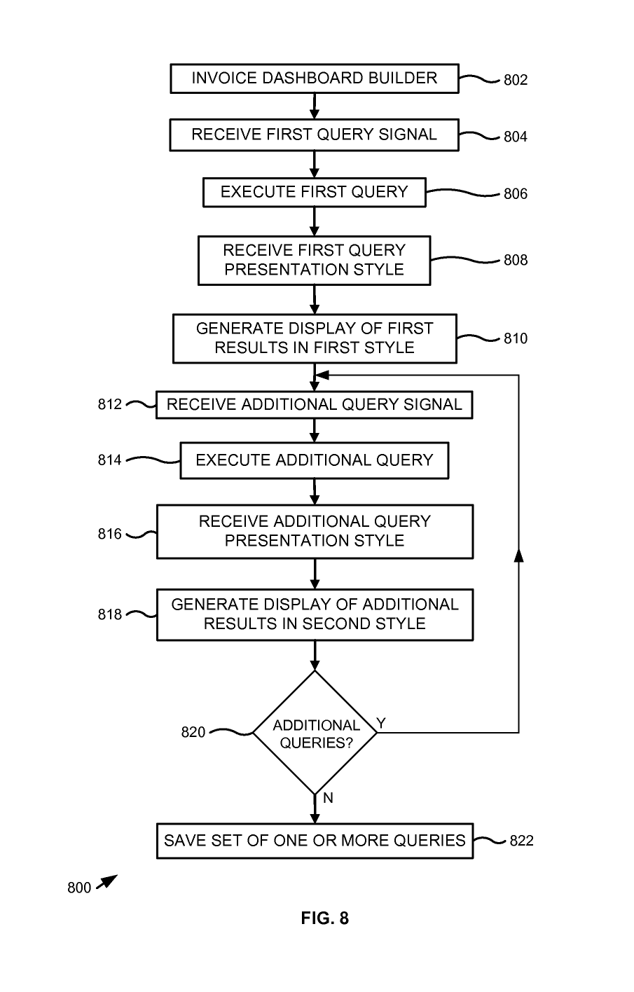

The functioning of the Dashboard builder module 240 is shown with reference to FIGS. 7 and 8. As shown in FIG. 8, selection of the Schedule tab 358 (FIG. 3) as shown at 802 invokes the Dashboard Builder module 240 (FIG. 2) of the system wherein, selectively, a user interface is generated having an input section 702 for receiving user parameters for conducting an analysis and a display section 704 presenting the retrieved data to the user in a visual dashboard display (FIGS. 7h-j) having multiple user-selectable graphical dashboard panes 790, 792, 794, and 796 (FIGS. 7h-j). In the example embodiment, the visual dashboard display 704 finds particular utility for interfacing a user with an associated database in an intuitive and time saving manner.

As shown in FIG. 7a, the Dashboard Builder module includes a graphical user interface 700 which allows the user to select the parameters for conducting market analyses. In accordance with the dashboard builder method of the example embodiment, a first query selection is received as shown at 804. Query parameter selections are received by means of parameter input section 702 wherein, as illustrated, the query data includes an airline and airport input section 706, an output data selection section 708, and a report period selection section 710. The input section 706 includes a Dom Marketing Airline(s) dialog entry box 712 for enabling the user to insert one or more dominant marketing airline codes for limiting the query results to journey data having the selected dominant marketing airline identifier. A Dom Operating Airline(s) dialog input box 714 enables a user to insert one or more dominant operating airline codes for limiting the query results to journey data having the selected dominant operating airline identifier.

An Origin Airport(s) dialog box 716 enables an user to insert one or more 3-character IATA airport codes for limiting the query results to journey data having the selected journey start identifier. Operationally, the Origin Airport data limits the data set resulting from the query to records with a specific list of trip origin airports. Similar to the Origin Airport(s) dialog box 716, the Destination Airport(s) dialog box 718 enables an user to insert one or more 3-character IATA airport codes for limiting the query results to journey data having the selected journey end identifier. The Destination Airport data limits the data set resulting from the query to records with a specific list of trip destination airports.

A Market(s) dialog box 720 enables the user to provide or otherwise supply a comma-separated list of 6-character markets, where each market is a concatenation of two airport IATA codes. The Market data limits the data set resulting from the query to records with a specific trip origin-destination pair. Markets are subject to the report's Directionality, so for Directional reports, each market pair is an Origin Airport followed by a Destination Airport. Markets may be used in addition to the Origin and Destination fields to further broaden the scope of the query.

A Connect Point(s) dialog box 722 enables the user to provide or otherwise supply a 3-character IATA airport code for identifying a travel connection point. In accordance with the example embodiment, the user may enter a comma-separated list into the Connect Point(s) dialog box 722 using plural IATA airport codes for identifying multiple non-ordered travel connection points. The Connect Point data limits the data set resulting from the query to records which have one or more of the listed connection points. In the example embodiment, and as a default, the Connect Point(s) dialog box 722 is left blank by the user, allowing travel routes with any or no connect points to be included in the database query.

A Directionality field drop down dialog box 724 receives selection data from the user permitting the user to choose a directionality as one of the query parameters. In accordance with the example embodiment, a user can select: Directional, Bi-Directional, Bi-Directional Total, or Non-Directional. A selection of Non-Directional parameter data effects an averaging of the data from both directions of travel into a single set of figures. A selection of Directional is used by the system to show figures for the direction requested, only. A selection of Bi-Directional causes the system to show figures for each direction flown, and a selection of Bi-Directional Total causes the system to show figures for each direction summed together.

By way of example of use of the Directionality field drop down dialog box 724 in accordance with an example embodiment, a selection of Directional: Origin JFK and destination LAX will query the system accordingly and will return only JFK-LAX data A selection of Bi-Directional: Origin JFK and destination LAX will query the system accordingly and will return both JFK-LAX and LAX-JFK data. A selection of Bi-Directional Total Origin JFK and destination LAX will query the system accordingly and will return the sum of JFK-LAX and LAX-JFK. Lastly, a selection of Non-Directional: Origin JFK and destination LAX will query the system accordingly and will return the average of JFK-LAX and LAX-JFK.

With continued reference to FIG. 7a, a set of check box inputs 726-740 are presented to the user of the Dashboard Builder in the output data selection section 708. The check box inputs 726-740 enable the system to receive a plurality of binary (yes/no, on/off, etc.) query options from the user. In the example embodiment, however, the options selectable by the user are limited to yes/no inputs for ease of illustration of the embodiment and not for purposes of limiting same.

A Show Dom Mktg Airlines input field 726 is configured to receive from the user a yes/no binary input wherein an uncheck box causes the system to aggregate the figures for all dominant marketing airlines together. A check in the input field 726 causes the system to break data down to different rows for each airline. Overall, therefore, in the example embodiment, an enabled Show Dom Mktg Airlines input field 726 causes the query and resultant report to break out results by dominant marketing carrier. If disabled, the system is operative to cause the report to provide aggregate results across all dominant marketing carriers.

A Show Dom Oper Airlines input field 728 is configured to receive from the user a yes/no binary input wherein an uncheck box causes the system to aggregate the figures for all dominant operating airlines together into the marketing airline. A check in the input field 728 causes the system to break data down to different rows for each airline. Overall, therefore, in the example embodiment, an enabled Show Dom Oper Airlines input field 728 causes the query and resultant report to break out results by dominant marketing carrier. If disabled, the system is operative to cause the report to provide total aggregate results across all dominant marketing carriers.

A Show Journey Origin input field 730 is configured to receive from the user a yes/no binary input wherein, when disabled, journey origins are removed from the report results and quantitative data is summed for all journey origins. When enabled, information is shown on a per journey origin basis. Overall, therefore, in the example embodiment, an enabled Show Journey Origin input field 730 causes the query and resultant report to break out results by trip origin. If disabled, the system is operative to cause the report to provide aggregate results across all trip origins.

A Show Journey Destination input field 732 is configured to receive from the user a yes/no binary input wherein, when disabled, journey destinations are removed from the report results and quantitative data is summed for all journey destinations. When enabled, journey information is shown on a per journey origin-destination pair basis. Overall, therefore, in the example embodiment, an enabled Show Journey Destination input field 732 causes the query and resultant report to break out results by trip destinations. If disabled, the system is operative to cause the report to provide aggregate results across all trip destinations.

A Show Journey Markets Destination input field 734 is configured to receive from the user a yes/no binary input wherein, when enabled, information is shown on a per-market basis. Operationally, the Show Journey Markets Destination data is exclusive/duplicative of the Show Journey Origin and Show Journey Destination data described above. When enabled, journey information is shown on a per journey destination basis. Overall, therefore, in the example embodiment, an enabled Show Journey Destination input field 734 causes the query and resultant report to break out results by trip origin-destination pair. If disabled, the system is operative to cause the report to provide aggregate results across all trip origin-destination pairs.

A Show Connections input field 736 is configured to receive from the user a yes/no binary input wherein, when disabled, connection points are removed from the report results and quantitative data is summed for all connect points. When enabled, information is shown on a per connect point basis. Overall, therefore, in the example embodiment, an enabled Show Connections input field 736 causes the query and resultant report to break out results by connecting point. If disabled, the system is operative to cause the report to provide aggregate results across all connecting points.

A Show RBKD(s) input field 738 is configured to receive from the user a yes/no binary input wherein an uncheck box causes the system to aggregate the figures for all the Reservation Booking Designators (RBKD) together. A check in the input field 738 causes the system to break data down to different rows by RBKD. Overall, therefore, in the example embodiment, an enabled Show RBKD input field 738 causes the query and resultant report to break out results by RBKD code. If disabled, the system is operative to cause the report to provide aggregate results across all RBKD codes.

Lastly, a Show Leg Miles input field 740 is configured to receive from the user a yes/no binary input wherein, when disabled, leg mileage is removed from the report results and quantitative data is summed for all leg mileage. When enabled, information is shown on a per leg mileage basis. That is, when enabled, multi-leg flights in the report have information broken out on a per-leg basis, and when disabled, multi-leg flights only show aggregate information.

With further continued reference to FIG. 7a, a Show Pax & Revenue Per data field drop down dialog box 742 enables the system to receive, from the user, a choice of a Period to view aggregate statistics for the entire purchase or travel period. In accordance with this data, the system of the example embodiment filters data keyed on travel periods. Alternatively, a choice of Travel Day or Purchase Day is provided to the user to view data averaged on a daily basis for each respective choice. Overall therefore, in the example embodiment, the user may select: Period, Per Travel Day, or Per Purchase Day, wherein a selection of Period returns aggregate values for the whole period, a selection of Per Travel Day (wherein a Travel Period must be selected as described below) returns average results per day in the travel period, and a selection of Per Purchase Day (wherein a Purchase Period must be selected as described below) returns average results per day in the purchase period.

An Only Show Details data field drop down dialog box 744 is available for use by the user to prune data where the market share percentage is less than the chosen value. The Only Show Details data sets the minimum share of the aggregate record set required in order to be displayed. In the example embodiment illustrated, the data field selections in the Only Show Details data field drop down box 744 include, for example: 5%, 1%, 0.5%, 0.25%, 0.125%, and 0.0%.

A Data Columns to Report data field drop down dialog box 746 receives selection data from the user permitting the user to choose the level of granularity of columns to show in the report. The data field selections in the drop down box 746 are arranged in increasing granularity order and include, for example: Minimal, Standard, and Full.

A Purchase Time Series data field drop down dialog box 748 receives selection data from the user permitting the user to breakdown the retrieved purchase data by a specific time period, such as day, month, or quarter. When performing a query against more than one purchase date, the user may choose to breakdown the data by a specific time period, with the breakdown of each specific time period going vertically down the report or horizontally across the report.

A Travel Time Series data field drop down dialog box 750 receives selection data from the user permitting the user to breakdown the retrieved travel data by a specific time period, such as day, month, or quarter. When performing a query against more than one travel date, the user may choose to breakdown the data by a specific time period, with the breakdown of each specific time period going vertically down the report or horizontally across the report.

A Travel Period field drop down dialog box 752 receives selection data from the user, wherein the received data selection is used by the system to select a ticket purchase window for the database query. Multiple time series options are selectable. The selected Travel Period data is used by the system to control the display of the query data results. The data field selections in the drop down box 752 include, for example: All, Single date, Single month, Single quarter, Single year, Range of months, Range of dates, Compare two date ranges, Compare two months, Compare two quarters, and Compare two years. The selection of the Travel Period causes report to return records which traveled during the period specified.

As illustrated, a Single Quarter is selected and “Q4” is selected in the date data field 754 and the year “2011” is elected in the year data field 756.

A Purchase Period drop down dialog box 758 receives selection data from the user, wherein the received data selection is used by the system to filter in accordance with the selected purchase period window. Multiple time series options are selectable by the user, wherein the selection causes the report to return records in which tickets were purchased during the period specified.

The data field selections in the drop down box 758 include, for example: All, Single date, Single month, Single quarter, Single year, Range of months, Range of dates, Compare two date ranges, Compare two months, Compare two quarters, and Compare two years.

A Departure Time drop down dialog box 760 receives selection data from the user, wherein the received data selection is used by the system to filter in accordance with the selected departure time. A window in 24-hour format is selected to include flights departing between those times. Early morning business flyers may be segregated from the data set, for example, by setting the departure time range to 05:00-08:00. Alternatively, all flights may be included in the results by selecting a full 24 hours. As illustrated in the example embodiment, the flight departure time range is selected as: 00:00-23:00 to 00:00-23:00, and causes report to return records in which travel took place at a certain time of day.

A Fare Basis Codes drop down dialog box 762 receives selection data from the user, wherein the received data selection is used by the system to filter fare basis codes by whether they start with a portion (start with), end with a portion (ends with), contain a portion (contain), or are exactly the same as a portion (equal). List may be entered, separated by commas, and blank fields maybe used to reveal information for all tickets, for example. The data field selections in the drop down box 762 include, for example: Contains, Starts with, Ends with, and Equals. A user enters the specific Fare Basis Code or Codes in the dialog entry box 764, which is limited by the selection from the Fare Basis Code drop down dialog box 762.

Lastly with reference to FIG. 7a, a Trip RBKD(s) Filter drop down dialog box 766 receives selection data from the user, wherein the received data selection is used by the system to search results by Revenue Booking Designators. One or more RBKD are selected (multi-select by holding the Control key down) to return only the data for specified revenue booking designators. Alternatively, choose All Designators to widen the scope to all revenue booking designators. The data field selections in the drop down box 760 include, for example: A-Z.

Invoking the Run Report user interface input button 768 with the report type selector button 770 set to Chart causes the system to execute the a first query as shown at 806 to selectively retrieve first result data from the associated database in accordance with the first query selection. It is to be appreciated that the report type selector button 768 includes a set of choices for selection by the user for the presentation of the query result data. These choices include but are not limited to, displaying the data in graphical presentation styles comprising at least one of a graphical map, a graphical heat map, a graphical chart, a bar graph, a standard chart, a line chart, a line and bar chart, a pie chart, a bubble chart, a plot chart, a stacked bar chart, a histogram chart, an area chart, a point heat map, or a chart map. As shown in FIG. 8, a first query result is received as shown at 808 including data specifying a first graphical presentation style selected from the list identified immediately above.

After the first query is executed, a display is generated as shown at 810 for displaying the first result data in the display section 704 in the first graphical presentation style in a user interface first graphical display 790a in accordance with the first query result. As shown in FIG. 7a, the first graphical display 790a is a standard bar chart displayed in the first dashboard pane 790.

The display section 702 includes a control panel section 772, having a number of interface tabs configured to allow the user to select or control various functions of the display section of the Dashboard Builder. In the example embodiment, the control panel section 772 includes a Fields tab 774, a Legend tab 776, a Date tab 778, and an Options tab 780.

When the user selects the Fields tab 774, the user is presented with a drop down selection box 774a as shown in FIG. 7b, which is configured to allow the user to select the fields to be included in the graphical display. It is understood that the fields to be selected may include any number of data fields or categorical fields. It is also understood that each data field or categorical fields can be selected or deselected as desired by the user or based on the type of graphical display desired. When the user changes the categorical fields selected, the data fields are re-aggregated to provide new values reflecting the change in the categorical breakdown of the data and the categorical fields which are not selected are not shown in the graphical display. As shown in FIG. 7b for illustration purposes only, the user may select the categorical fields to be included, such as dominant marketing airline, journey origin airport, and journey destination airport. As further shown in FIG. 7b, the user may also select specific data fields to be included in the analysis, such as journey miles, passengers, journey fare, journey gross revenue, journey revenue, and journey gross revenue.

When the user selects the Legend tab 776, the user is presented is drop down selection box 776a, as shown in FIG. 7c, which is configured to allow the user to select the symbols, characters, or other identifiers used to represent the data in the graphical display. It is understood the user may select any number of identifiers to be used to represent the data. In one embodiment, the user may sort the legend identifiers as desired. As shown in FIG. 7c for illustration purposes only, the user may select the view to be shown, the journey origination airport legend, and the journey destination airport legend. As an example of the view to be shown, the user may select to sort by passenger, or some other field. The user may then select to show only the top 50%, only the top 25%, only the top 10%, all of the results, and the order of the results, such as inverse order.

When the user selects the Date tab 778, the user is presented with a date drop down selection box 778a as shown in FIG. 7d, which is configured to receive input from the user for selecting specific time periods to be included in the graphical display. As shown in FIG. 7d for illustration purposes only, a Travel Period field drop down dialog box 778b receives selection data from the user, wherein the received data selection is used by the system to select a ticket purchase window for the results. The data field selections in the drop down box 778b include, for example: All, Single date, Single month, Single quarter, Single year, Range of months, Range of dates, Compare two date ranges, Compare two months, Compare two quarters, and Compare two years. As illustrated, a Single Quarter is selected and “Q4” is selected in the date data field 778c and the year “2011” is elected in the year data field 778d.

A Purchase Period drop down dialog box 778e receives selection data from the user, wherein the received data selection is used by the system to filter the data shown in the graphical display in accordance with the selected purchase period window. The data field selections in the drop down box 778e include, for example: All, Single date, Single month, Single quarter, Single year, Range of months, Range of dates, Compare two date ranges, Compare two months, Compare two quarters, and Compare two years. It is understood that the Dashboard Builder module also includes the functionality to allow the user to alter the start date, end date, or both, prior to, during, or after performing a market analysis. The user may then select the Update button 778f to update the results.

When the user selects the Options tab 780, the user is presented with a drop down selection box 780a, as shown in FIG. 7e, which is configured to allow the user to select from various options. Such options may include, but are not limited to, display options for the graphical display, sort options, map projection options, display size options, and the like. Upon the selection of a desired option by the user, the user is presented with a suitable interface as is known in the art for selecting the desired parameters for the desired option. It is understood that the Options tab may suitably have the functionality to allow the user to select from multiple display formats, such as table mode and map mode; map projections, such as equirectangular, Mercator, and Miller; sizing options, such as zoom, pan, and size adjustment; and variable parameters. As shown in FIG. 7e for illustration purposes only, the user may select the title for the graphical display and whether to show the title with the graphical display. The user may select the type of display for the graphical display and if to show the legend information. The user may further select whether to show labels, whether to show shadow, whether to show data tips, and whether to show the axes for the graphical display, including the category type and the value. The user may also select the angle for the labels for the horizontal axis and for the vertical axis, as well as the font size. The user may include any notes desired related to the graphical display.

FIG. 7f shows the final version of the first graphical display, illustrating the display showing the number of passengers for the journey originating airport and the journey destination airport as selected in the Fields tab. The final version also illustrates the number of passengers as sorted by the number of passengers and only the top 50% as selected in the Legends tab. The final version further shows the graphical display with the edited title and labels as selected in the Options tab. The chart may be displayed as a table by selecting the drop-down menu 784 and selecting the Table option.

In still further accordance with the Dashboard Builder module of the example embodiment, an additional query selection is received as shown at 812. Invoking the Run Report user interface input button 768 with the report type selector button 770 set to Chart causes the system to execute the second query as shown at 814 to selectively retrieve additional or second result data from the associated database in accordance with the additional query selection. As shown in FIG. 7g, when the user selects the Chart Type Selection button 782, a dialog box 784 opens presenting the user with several options for the second graphical presentation style for the second graphical display. As shown in FIG. 7g for illustration purposes only, the graphical presentation styles include standard chart, line chart, line and bar chart, pie chart, bubble chart, plot chart, stacked chart, area chart, point heat map, chart map, and routes map. It is understood that the dialog box may suitably include any number of types of graphical presentation styles other than those presented in FIG. 7g.

In accordance with the method, an additional query result is received as shown at 816 including data specifying a second graphical presentation style selected from the list identified immediately above. It is also understood that the additional query may be the same as the first query, with the query result data shown in different graphical presentation data. For example, the first query result data may be shown as a bar chart and the second query result data may be shown as a heat-map format.

Once the user has selected the graphical presentation style for the second graphical display, the user invokes the Run Report button 768, a display is generated as shown at 818 in the display section 704 showing the first graphical display 790a in the first graphical presentation style in the first dashboard pane 790, and a second graphical display 792a in a second graphical presentation style in a second dashboard pane 792, as shown in FIG. 7h.

As discussed above, the user may invoke any combination of the Fields tab 774, Legend tab 776, Date tab 778, and Options tab 780 in the control panel section 772 to allow the user to select or control various functions of the display section of the Dashboard Builder. As shown in FIG. 7i, the user has deleted the journey destination airport field in the Fields tab 774, and edited the title and labels for the second graphical display as shown in second visual pane 792.

Referring to FIG. 8, after the graphical display is generated for the additional query results as shown at 818, the method proceeds to 820, wherein a determination is made if the user desires to perform additional queries using the Dashboard Builder module. If the user does not desire to perform any additional queries, the method proceeds to 822, wherein the user may save the query selection data as discussed below. In the event the user desires to perform additional queries, the method returns to step 812, wherein an additional query selection is received, and the process continues as discussed above to generate additional graphical displays. It is understood that the number of queries described herein are for illustrative purposes only, and that the number of queries may be any number that is feasible within the constraints of the system on which the Dashboard Builder module operates. In accordance with an enhanced convenient feature of the example embodiment, each of the queries as well as the presentation styles to be associated with the graphical displays can be selectively saved by the user in memory 110 of the system for later re-use as necessary or desired.

In an example embodiment for illustration purposes only, the first and second query selections, as well as the graphical presentation styles associated therewith, as shown in FIG. 7i, are saved as Test Dashboard. To save a query selection, the user invokes the Save button 786 at the top left of the display section 704 as shown in FIG. 7j. If the user desires to retrieve the saved query selections, the user invokes the Open Saved Query Selection button 788 at the top left of the display section 704 as shown in FIG. 7j. Additionally, the user may elect to print a given chart or dashboard as a picture by invoking the Print button 787, or export them in a standard picture file format by invoking the Export button 789.

In the example embodiment, the user desires to retrieve the first and second query selections for the Test Dashboard, and invokes the Open Saved Query Selection button 788 to do so. The stored first and second query selections are retrieved from the memory. The retrieved first query is executed to selectively retrieve first result data from the associated database in accordance with the first query selection retrieved from the memory. The retrieved second query is executed to selectively retrieve second result data from the associated database in accordance with the second query selection retrieved from the memory. A display is generated for displaying the first graphical display in the first graphical presentation style in accordance with first query result in the first dashboard pane 790, and for displaying the second graphical display in the second graphical presentation style in accordance with the second query result in the second dashboard pane 792 as shown in FIG. 7j.

Still further in the example embodiment, the user provided query selection data and graphical presentation style as described above for the system to perform a third query and to display a third graphical display in a third graphical presentation style in a third dashboard pane 794 as shown in FIG. 7j. As shown in FIG. 7j, the user selected to perform a query related to the onboard region passenger data for the origin airports used in the first query selection (CDG and LHR) as shown in FIG. 7a. The user selected the graphical display to show the departures and the average passenger per departure. The user then saves the first and second query selection data with the third query selection data to update the Test Dashboard.

Still further in the example embodiment, the user provided query selection data and graphical presentation style as described above for the system to perform a fourth query and to display a fourth graphical display in a fourth graphical presentation style in a fourth dashboard pane 796 as shown in FIG. 7j. As shown in FIG. 7j, the user selected to perform a query related to frequent flier data to illustrate the number of frequent flier miles earned during selected journeys. The user selected the graphical display to show the frequent flier miles earned during selected journeys. The user then saves the first, second, and third query selection data with the fourth query selection data to update the Test Dashboard. It is understood that the number of queries described herein are for illustrative purposes only, and that the number of queries may be any number that is feasible within the constraints of the system on which the Dashboard Builder module operates.

The Dashboard Builder module allows a user to generate a visual dashboard display which is customized by the user. As discussed above with respect to the Fields tab 774, the Legends tab 776, the Date tab 778, and the Options tab 780, the user has the ability to select any number of parameters to display in any number of formats or presentation styles. The user has the ability to select which fields or data to include in the analysis and the type of chart, map, or table in which to display the data. As an example, a user could select a bar chart to illustrate a bar series for passengers, revenue, fare, and yield. As a further example, the user could break down the bars by airline, origin, destination, market, and fare class. It is understood that the customization selected by the user is performed by the system or platform local to the user once the data has been received from the underlying system of the subject application.

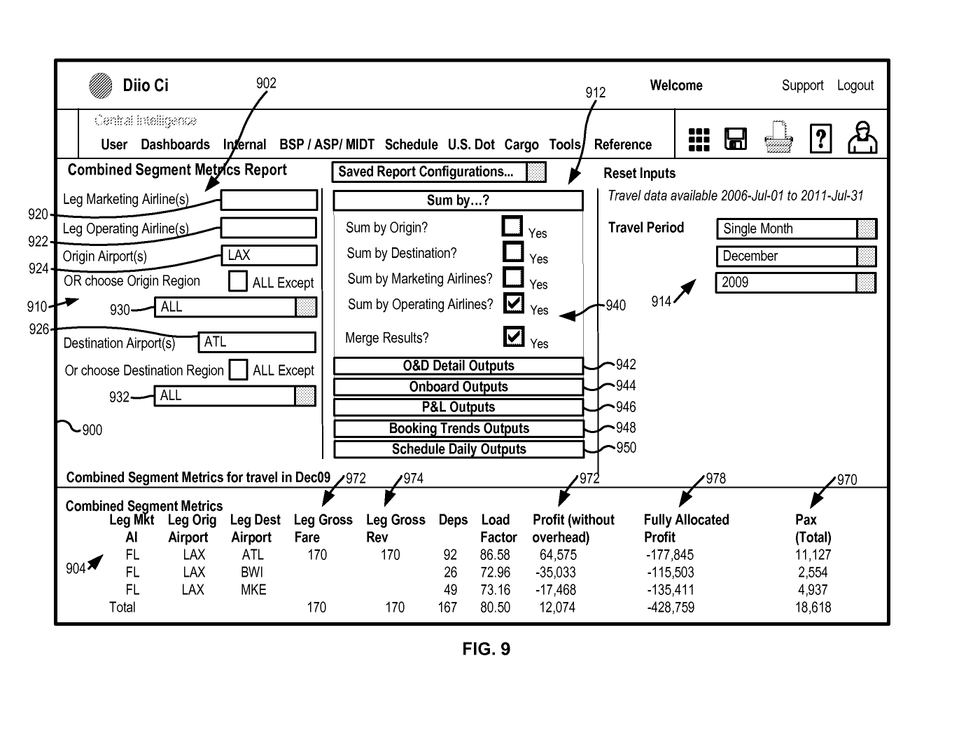

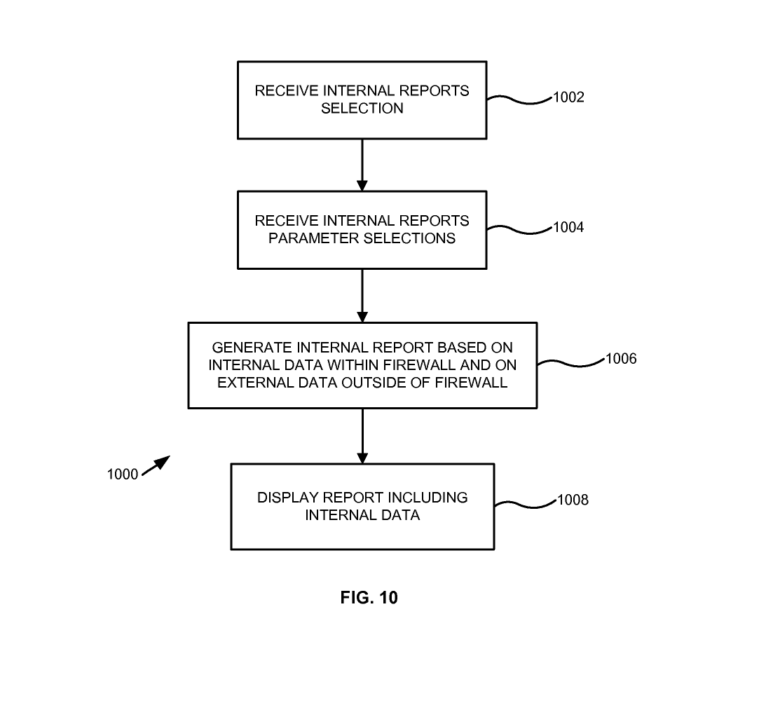

The functioning of the merge module is shown with reference to FIGS. 9 and 10. As shown in FIG. 9, the selection of the Internal tab 354 (FIG. 3), as shown at 1002 invokes the merge module 230 wherein a combined segment matrix report interface 900 is presented to the user. In accordance with this example embodiment, the combined segment matrix report interface 900 enables users of the system to retrieve selected data and compile desired reports based on proprietary non-published data contained in internal database 125 in combination with data from one or more published or unpublished databases 150, 152, 154. Proprietary data includes, for example, profit and loss data, sales data, costs data, and the like. The matrix report interface 900 includes and upper parameter input section 902 and a lower report display section 904. Internal report parameter selections are received as shown at 1004 by means of parameter input section 902 wherein, as illustrated, the query data includes an airline and airport input section 910, an output data selection section 912, and a report period selection section 914. The input section 910 includes a dialog entry box 920 for inputting a leg marketing airline code, a dialog input box 922 for inputting a leg operating airline code, a dialog input box 924 for inputting a three digit code for an origin airport and a dialog input box 926 for inputting, by the user, a destination airport code. Drop down dialog boxes 930, 932 provide means for receiving into the system origin and destination regions, respectively.

The output data selection section 912 includes a plurality of selection sets including a sum and merge selection set 940, an O and D detail output section 942, an onboard output section 944, a P&L output section 946, a booking trends output section 948, and a daily schedule output section 950. Each of the output data selection section 912 configures the system 100 for receiving internal report parameter selections as shown at 1004. In accordance with the example embodiment, the O and D detail outputs include selections available to users including: leg fare, leg gross fare, leg revenue, leg gross revenue, leg RPM, leg yield, fuel charge, surcharge fee, international fees, and the like. The onboard output selection section 944 provides means in the system for receiving combined segment matrix report data including average passengers, average seats, average load factor, average passengers upgrading, average passengers on standby, and the like. Similarly, the P&L output parameter selection data section 946 enables the system 100 to receive data for tuning the report set out in the report display section 904 wherein parameters include fuel cost, fully allocated profit, profit without overhead, flight crew cost, flight variable cost, passenger variable cost, ownership cost, overhead cost, total cost, segment passenger revenue, local passenger revenue, O and D passenger revenue, other revenue, cargo revenue, and the like. Still further, the booking trend output section 948 configures the system for receiving booking trend data for forming an output report in accordance with passengers, revenues, fares, or the like. Still further, the schedule daily output section 950 enables the system to receive data for selecting output parameters for generating the combined segment matrix report, wherein the selections include flights, seats, block minutes (flight time from gate to gate), total miles, distance, and ASM. Similarly, the report period selection section 914 configures the system for receiving travel period selection data including a plurality of drop down menu boxes 952 for enabling the user to select from various time periods for tuning the output report generated.

The Merge module includes the functionality such that the summing and merge of the selected data from each of the selected databases is performed in parallel in the same manner to ensure that the merged results include the same types or categories of data. As an example, if a user desires to merge data relating to segment metrics from an internal proprietary database and the DOT database, such as data relating to leg originating airport, leg destination airport, and leg gross fare, the Merge module functions to ensure that the set of data merged from the internal database and set of data merged the DOT database include the data relating to such metrics. The Merge module functions to retrieve disparate data from multiple databases and reduce the data retrieved to the common overlap between the databases.

In the example illustrated in FIG. 9, the report period selections section 914 is configured to receive travel period data for limiting the matrix report to a single month, mainly December 2009. In addition, the airline and airport input section 910 is configured to enable the system to receive an originating airport of Los Angeles (LAX). Using the data as shown and received into the system, an internal report is generated 1006 based on internal data within the firewall 140 such as, for example, data contained in the proprietary database 125 of host 124, as well as based on external data outside of the firewall 140 such as, for example, databases 150, 152, 154 associated with a network 128 outside the firewall 140. An example report 970 is shown in FIG. 9 in the report display section 904. The report is displayed 904 including internal data, such as, for example, gross fare data 972, leg gross revenue 974, profit without overhead data 976, and fully allocated profit 978.

It is understood that while the example embodiment illustrates merging data from an internal proprietary database with data from a non-proprietary or public database to generate a combined report, the Merge module also includes the functionality to merge data from multiple internal proprietary databases or from multiple non-proprietary databases. The Merge module also includes the functionality to merge data from one or more internal proprietary databases with data from one or more non-proprietary databases. As an example, the Merge module may function to merge data from an internal propriety database with data from the DOT database and data from the IATA database to generate a desired report.

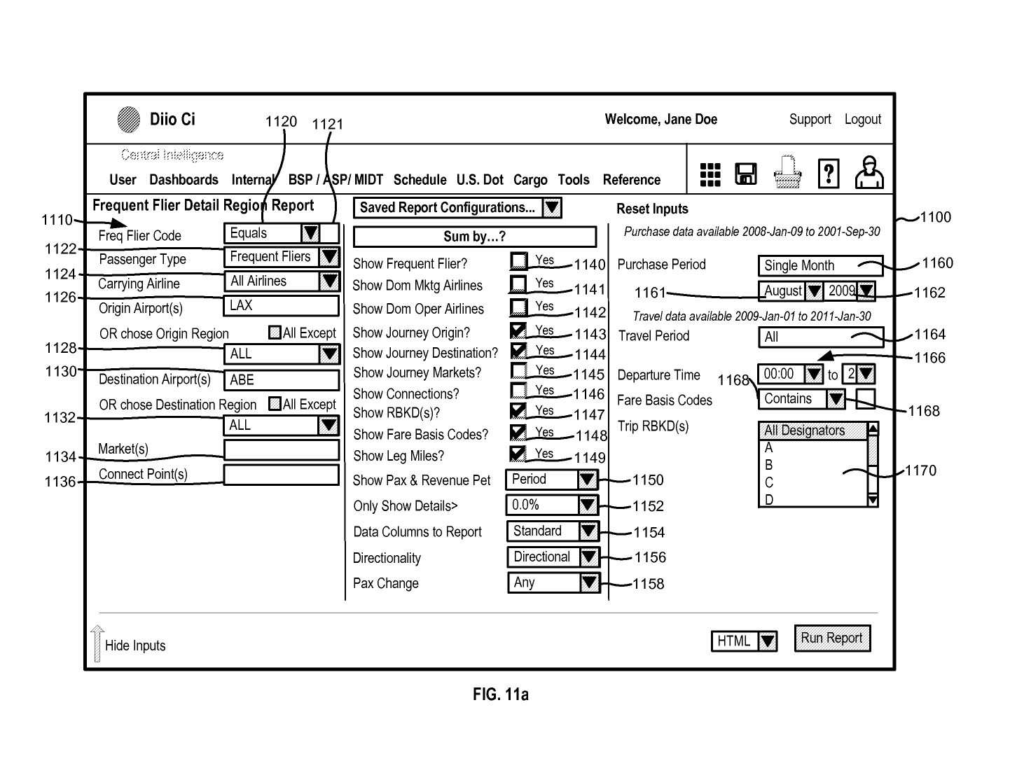

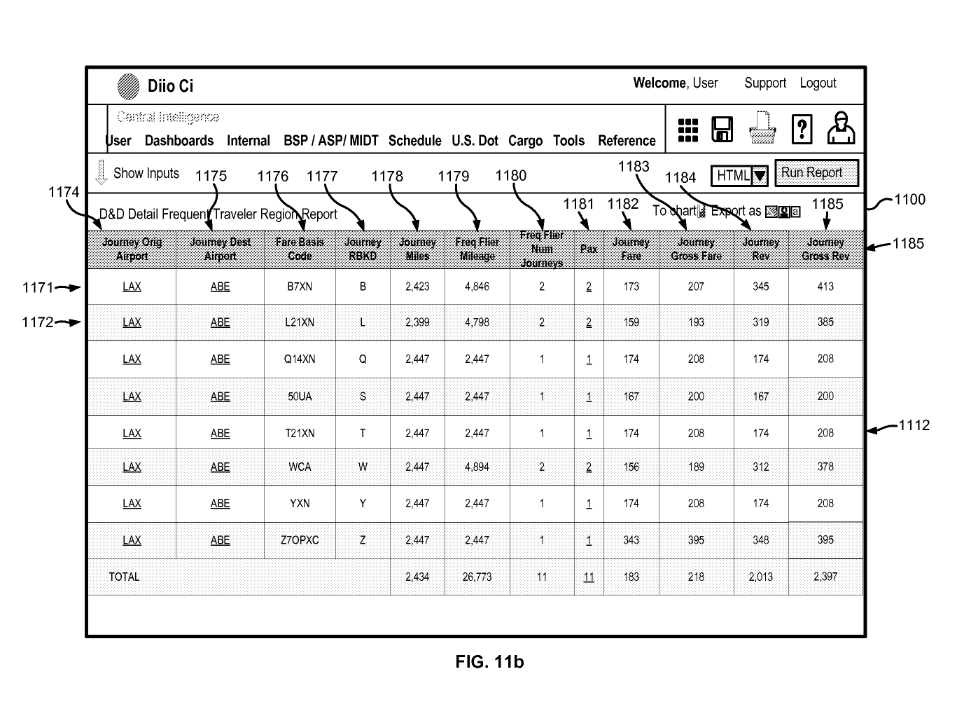

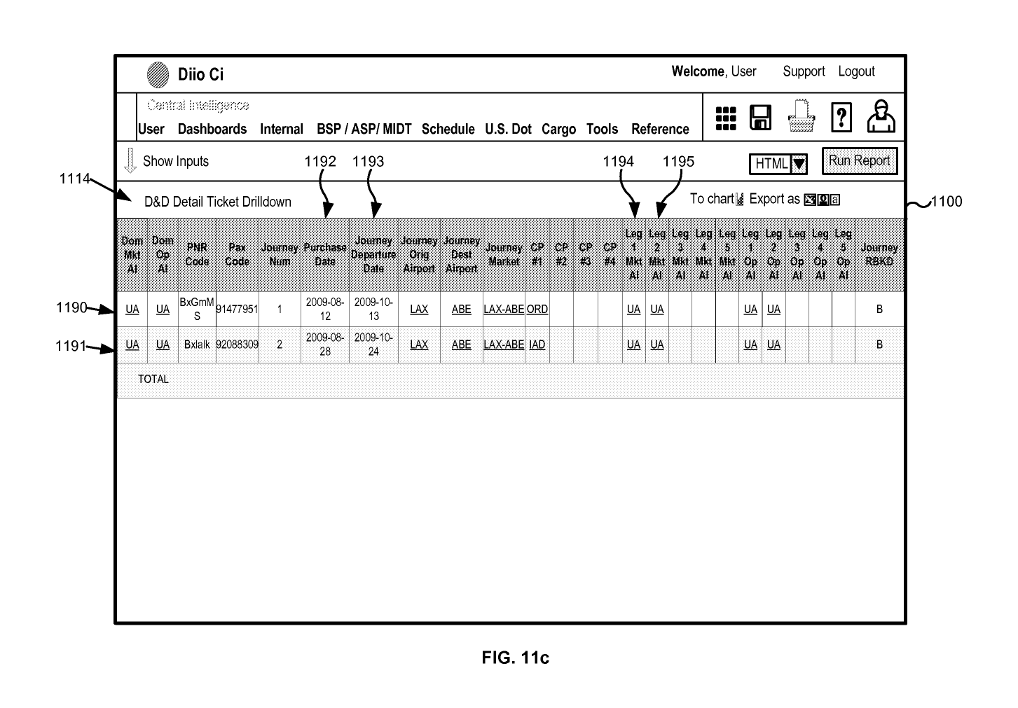

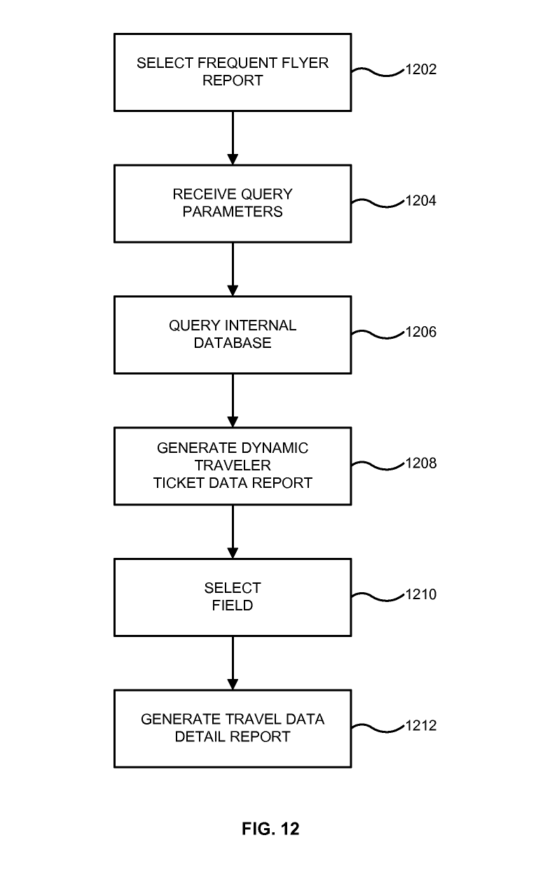

With reference next to FIGS. 11a-11c and 12, the functioning of the frequent flier data report module for generating dynamic user interfaces for generating reports for intuitive analysis of internal frequent flier data will be described. As shown in FIG. 10, the selection of the Internal tab 354 as shown at 1202, followed by a selection of one or more sub-tabs (not shown) under the Internal tab in the example embodiment, invokes the Frequent Flier Report module 230 of the interface system 200 wherein, selectively, a Frequent Flier Report interface 1100 (FIGS. 11a-11c) is displayed. In the example embodiment, the associated user is presented initially with a data input interface display 1110 shown in FIG. 11a. The system is configured to receive as shown at 1204 a set of query data for purposes of establishing a search query directed to the data contained in the internal proprietary database 125. In the example, internal frequent flier data is queried for developing a linkage for presentation to the user of the system tying frequent flier ticket purchase data with frequent flier travel data. A benefit of this report is that it presents the user with a comparison, based on traveler personal name record (PNR) data, between information indicating what the traveler planned to do (using ticket purchase data) against information indicating what the frequent flier traveler actually did (based on performance data drawn from the internal database 125).

In the example embodiment, a Frequent Flier Code data field drop down dialog box 1120 and a field box 1121 in the Frequent Flier Detail Region Report data input interface display 1110 enables the system to receive at step 1204, from the associated user, a data field type selection or designation. In accordance with this data, the system of the example embodiment filters frequent flier data keyed on frequent flier identifiers, whereby the data is filtered in accordance with whether the data starts with a portion (start with), ends with a portion (ends with), contains a portion (contain), or is exactly the same, in a case-insensitive fashion (equal) of the text data entered by the user in the associated field box 1121. Leaving the field box 1121 blank by the user enables the system to process the data and correspondingly for the associated user to see information that is unfiltered by frequent flier codes. That is, all tickets for all frequent fliers that match other criteria specified in the report.

Further in the example embodiment, a Passenger Type data field drop down dialog box 1122 in the data input interface display 1110 enables the system to receive, from the user, a data field selection for filtering the internal proprietary data contained on the internal database 125 in accordance with pre-selected passenger type information. The Passenger Type data field drop down dialog box 1122 filters results of a query of the internal database 125 by the passenger type assigned to the passengers by the owner of the proprietary data, such as an airline, for example. In particular, in the example embodiment, the Passenger Type data is used by the system to limit results to passenger tickets carrying appropriate frequent-flier status. The Passenger Type selections in the example embodiment relate to the “Star Alliance” airline group in the example embodiment. The user can select All passengers, Frequent fliers, Gold status fliers, Diamond status fliers, and Platinum status fliers.

A Carrying Airline data field drop down dialog box 1124 enables identification of a selected airline for further filtering of the internal proprietary data contained on the internal database 125 by the type of airline. The selections presented to the user the example embodiment include: Carrier airline, Alliance partners, and Code share partners.

An Origin Airport(s) dialog box 1126 enables an user to insert one or more 3-character IATA airport codes for filtering the internal proprietary data contained on the internal database 125 relative to journey data having the selected journey start identifier. Operationally, the Origin Airport data limits the data set resulting from the query to records with a specific list of trip origin airports and, further, is exclusive with Origin Region data to be described below. In accordance with an embodiment, if left blank, then the region from the choose country/region field to be described below will be used as the default origin location. However, for purposes of describing the example embodiment, a three letter code of “LAX” Los Angeles International airport is used.

An Origin Region dialog box 1128 enables an user to select from one or more countries or regions to be used as a parameter for further filtering of the proprietary frequent flier data by the system. Operationally, the Origin Region data limits the data set resulting from the query to records with a specific trip origin region, and can be set to “all except a given region” for example. In addition, the Origin Region data is exclusive with the Origin Airport data described above. In the example, the country or region selected as a search key is not used since the Origin Airport field in the Origin Airport dialog box 1126 is left blank.

The Origin Region selections in the example embodiment include, for example: All, Browse countries by name, Africa, Asia, Australasia, Australia, Caribbean, Central America, Europe, Middle East, North America, Canada, United States, South America, and Overlapping regions. It is understood that the Origin Region dialog box 1128 includes drill-down functionality. For example, upon selecting Australasia, the list will suitably update to display Browse All Regions (returns to top level of region list); Browse Australasian countries by name; All of Australasia (default choice); Australia; New Zealand; Trans-Tasman; and US DOT WAC Australasia. As a further example, upon selecting Browse Australasian countries by name, the drill-down list will suitably display Browse All Regions (returns to top level of the region list); Browse Australasia (returns to previous list); All of Australasia (default choice); Australia; Christmas Island; Cocos (Keeling) Island; Cook Island; East Timor; Fiji; French Polynesia; Kiribati; Marshall Islands; Micronesia; New Caledonia; Nauru; Niue; Norfolk Island; Palau; Papua New Guinea; Solomon Islands; Tonga; Tuvalu; US Minor Outlying Islands; Vanuatu; Wallis and Futuna Islands; and Western Samoa. As another example, upon selecting Australia, the drill-down list will suitably update to display New South Wales, Northern Territory, Queensland, South Australia, Tasmania, Victoria, and Western Australia.

Similar to the Origin Airport(s) dialog box 1126, the Destination Airport dialog box 1130 enables an user to insert one or more 3-character IATA airport codes for filtering the internal proprietary data contained on the internal database 125 relative to journey data having the selected journey end identifier. The Destination Airport data limits the data set resulting from the query to records with a specific list of trip destination airports. Operationally, the Destination Airport data is exclusive with the Destination Region data to be described below. In accordance with an embodiment, if left blank, then the region from the choose destination country/region field to be described below will be used. However, for purposed of describing the example embodiment, a three letter code of “ABE” is used to indicate, in the example, all journeys originating from LAX and terminating at ABE, Allentown, Pa.

A Destination Region dialog box 1132 enables the user to select from among one or more predetermined travel destination regions to be used as a parameter for further filtering of the proprietary travel data. Operationally, the Destination Region data is exclusive with the Destination Airport data to be described above. As with the Origin Region selection, the country or region selected as a search key is only used by the system if the data in the Destination Airport dialog box 1130 field is left blank by the user. The Destination Region data limits the data set resulting from the query to records with a specific trip destination region; and can be set to “all except a given region” for example. The Destination Region dialog box 1132 also includes the drill-down functionality as described with respect to the Origin Region dialog box 1130 above.

A Market(s) dialog box 1134 enables the user to provide or otherwise supply a comma-separated list of 6-character markets, where each market is a concatenation of two IATA airport codes. Operationally, the Market data is additive with the Origin/Destination Airport(s)/Region data. The Market data limits the data set resulting from the query to records with a specific trip origin-destination pair. Markets are subject to the report's Directionality, so for Directional reports, each market pair is an Origin Airport followed by a Destination Airport. Markets may be used in addition to the Origin and Destination fields to further broaden the scope of your query.

A Connect Point(s) dialog box 1136 enables the user to provide or otherwise supply a 3-character IATA airport code for identifying a travel connection point. In accordance with the example embodiment, the user may enter a comma-separated list into the Connect Point(s) dialog box 1136 using plural IATA airport codes for identifying multiple non-ordered travel connection points. The Connect Point data limits the data set resulting from the query to records which have one or more of the listed connection points. In the example embodiment, and as a default, the Connect Point(s) dialog box 1136 is left blank by the user, allowing travel routes with any or no connect points to be included in the database query.

With continued reference to FIG. 11a, a set of check box inputs 1140-1149 are presented to the user of the Frequent Flier Detail Region Report data input interface display 1110. The check box inputs 1140-1149 enable the system to receive a plurality of binary (yes/no, on/off, etc.) query options from the user. In the example embodiment, however, the options selectable by the user are limited to yes/no inputs for ease of illustration of the embodiment and not for purposes of limiting same.

A Show Frequent Flier input field 1140 is configured to receive from the user a yes/no binary input. When disabled by an unchecked field 1140, frequent flier identifiers are removed from the report results and quantitative data is aggregated for all frequent flier identifiers. When enabled by a checked box, information is shown on a per-frequent flier identifier basis. Overall, therefore, in the example embodiment, if the Show Frequent Flier input field 1140 is enabled, the system is operable to cause the report to list individual records (e.g., individual trips), and a disabled Show Frequent Flier input field 1140 causes the report aggregate records and return combined results.

A Show Dom Mktg Airlines input field 1141 is configured to receive from the user a yes/no binary input wherein an uncheck box causes the system to aggregate the figures for all dominant marketing airlines together. A check in the input field 1141 causes the system to break data down to different rows for each airline. Overall, therefore, in the example embodiment, an enabled Show Dom Mktg Airlines input field 1141 causes the query and resultant report to break out results by dominant marketing carrier. If disabled, the system is operative to cause the report to provide aggregated results for the dominant marketing carriers matching the other criteria provided.

A Show Dom Oper Airlines input field 1142 is configured to receive from the user a yes/no binary input wherein an uncheck box causes the system to aggregate the figures for all dominant operating airlines together into the marketing airline. A check in the input field 1141 causes the system to break data down to different rows for each airline. Overall, therefore, in the example embodiment, an enabled Show Dom Oper Airlines input field 1142 causes the query and resultant report to break out results by dominant marketing carrier. If disabled, the system is operative to cause the report to provide aggregate results across all dominant marketing carriers.

A Show Journey Origin input field 1143 is configured to receive from the user a yes/no binary input wherein, when disabled, journey origins are removed from the report results and quantitative data is summed for all journey origins. When enabled, information is shown on a per journey origin basis. Overall, therefore, in the example embodiment, an enabled Show Journey Origin input field 1143 causes the query and resultant report to break out results by trip origin. If disabled, the system is operative to cause the report to provide aggregate results across all trip origins.

A Show Journey Destination input field 1144 is configured to receive from the user a yes/no binary input wherein, when disabled, journey destinations are removed from the report results and quantitative data is summed for all journey destinations. When enabled, journey information is shown on a per journey origin-destination pair basis. Overall, therefore, in the example embodiment, an enabled Show Journey Destination input field 1144 causes the query and resultant report to break out results by trip destinations. If disabled, the system is operative to cause the report to provide aggregate results across all trip destinations.

A Show Journey Markets Destination input field 1145 is configured to receive from the user a yes/no binary input wherein, when enabled, information is shown on a per-market basis. Operationally, the Show Journey Markets Destination data is exclusive/duplicative of the Show Journey Origin and Show Journey Destination data described above. When enabled, journey information is shown on a per journey destination basis. Overall, therefore, in the example embodiment, an enabled Show Journey Destination input field 1145 causes the query and resultant report to break out results by trip origin-destination pair. If disabled, the system is operative to cause the report to provide aggregate results across all trip origin-destination pairs.

A Show Connections input field 1146 is configured to receive from the user a yes/no binary input wherein, when disabled, connection points are removed from the report results and quantitative data is summed for all connect points. When enabled, information is shown on a per connect point basis. Overall, therefore, in the example embodiment, an enabled Show Connections input field 1146 causes the query and resultant report to break out results by connecting point. If disabled, the system is operative to cause the report to provide aggregate results across all connecting points.

A Show RBKD(s) input field 1147 is configured to receive from the user a yes/no binary input wherein an uncheck box causes the system to aggregate the figures for all the Reservation Booking Designators (RBKD) together. A check in the input field 1147 causes the system to break data down to different rows by RBKD. Overall, therefore, in the example embodiment, an enabled Show RBKD input field 1147 causes the query and resultant report to break out results by RBKD code. If disabled, the system is operative to cause the report to provide aggregate results across all RBKD codes.

A Show Fare Basis Codes input field 1148 is configured to receive from the user a yes/no binary input wherein, when disabled, fare basis codes are removed from the report results and quantitative data is summed for all fare basis codes. When enabled, information is shown on a per-fare basis code basis. Overall, therefore, in the example embodiment, an enabled Show Fare Basis Codes input field 1148 causes the query and resultant report to break out results by fare basis code. If disabled, the system is operative to cause the report to provide aggregate results across all fare basis codes.

Lastly, a Show Leg Miles input field 1149 is configured to receive from the user a yes/no binary input wherein, when disabled, leg mileage is removed from the report results and quantitative data is averaged for all leg mileage. When enabled, information is shown on a per leg mileage basis. That is, when enabled, multi-leg flights in the report have information broken out on a per-leg basis, and when disabled, multi-leg flights only show aggregate information.

With further continued reference to FIG. 11a, a Show Pax & Revenue Per data field drop down dialog box 1150 in the Frequent Flier Detail Region Report data input interface display 910 enables the system to receive, from the user, a choice of a Period to view aggregate statistics for the entire purchase or travel period. In accordance with this data, the system of the example embodiment filters frequent flier data keyed on travel periods. Alternatively, a choice of Travel Day or Purchase Day is provided to the user to view data averaged on a daily basis for each respective choice. Overall therefore, in the example embodiment, the user may select: Period, Per Travel Day, or Per Purchase Day, wherein a selection of Period returns aggregate values for the whole period, a selection of Per Travel Day (wherein a Travel Period must be selected as described below) returns average results per day in the travel period, and a selection of Per Purchase Day (wherein a Purchase Period must be selected as described below) returns average results per day in the purchase period.

An Only Show Details data field drop down dialog box 1152 in the Frequent Flier Detail Region Report data input interface display 1110 is available for use by the user to prune data points whose values represent less than a given percentage of the total. The Only Show Details data sets the minimum share of the total recordset required in order to be displayed individually, in its own row. Data which has been pruned is aggregated into the OTHER row.

In the example embodiment illustrated, the data field selections in the Only Show Details data field drop down box 1152 include, for example: 5%, 1%, 0.5%, 0.25%, 0.125%, and 0.0%.

A Data Columns to Report data field drop down dialog box 1154 receives selection data from the user permitting the user to choose the level of granularity of columns to show in the report. The data field selections in the drop down box 1154 are arranged in increasing granularity order and include, for example: Minimal, Standard, and Full.

A Directionality field drop down dialog box 1156 receives selection data from the user permitting the user to choose a directionality feature in the Frequent Flier Detail Report. In accordance with the example embodiment, a user can select: Directional, Bi-Directional, Bi-Directional Total, or Non-Directional. A selection of Non-Directional parameter data effects an averaging of the data from both directions of travel into a single set of figures. A selection of Directional is used by the system to show figures for the direction requested, only. A selection of Bi-Directional causes the system to show figures for each direction flown, and a selection of Bi-Directional Total causes the system to show figures for each direction summed together.

By way of example of use of the Directionality field drop down dialog box 1156 in accordance with the example embodiment, a selection of Directional: Origin JFK and destination LAX will query the system accordingly and will return only JFK-LAX data in the resultant report. A selection of Bi-Directional: Origin JFK and destination LAX will query the system accordingly and will return both JFK-LAX and LAX-JFK data in the resultant report on separate lines. A selection of Bi-Directional Total: Origin JFK and destination LAX will query the system accordingly and will return the sum of JFK-LAX and LAX-JFK in the resultant report on a single line. Lastly, a selection of Non-Directional: Origin JFK and destination LAX will query the system accordingly and will return the average of JFK-LAX and LAX-JFK in the resultant report on a single line.

A Pax Change field drop down dialog box 1158 receives selection data from the user, wherein the received data selection is used by the system to filter results by the algorithm specified. The data field selections in the drop down box 1158 include, for example: Decrease of 100%, Decrease of 50% or more, Decrease of 40% or more, Decrease of 30% or more, Decrease of 20% or more, Decrease of 10% or more, Increase of 10% or more, Increase of 20% or more, Increase of 30% or more, Increase of 40% or more, Increase of 50% or more, and Increase of 100% or more.

A Purchase Period field drop down dialog box 1160 receives selection data from the user, wherein the received data selection is used by the system to select a ticket purchase window for the database query. The user can chose from one of several ticket purchase date options. The selected Purchase Period data is used by the system to control the display of the query data results. The data field selections in the drop down box 1160 include, for example: All, Single date, Single month, Single quarter, Single year, Range of months, Range of dates, Compare two date ranges, Compare two months, Compare two quarters, and Compare two years. The selection of the Purchase Period causes report to return records in which tickets were purchased during the period or periods specified.

As illustrated, a Single Month is selected and “August” is selected in the month data field 1161 and the year “2009” is elected in the year data field 1162.

A Travel Period drop down dialog box 1164 receives selection data from the user, wherein the received data selection is used by the system to filter in accordance with the selected passenger(s) travel window. The use can choose from one of several ticket travel date options, wherein the selection causes the report to return records which traveled during the period or periods specified.

The data field selections in the drop down box 1164 include, for example: All, Single date, Single month, Single quarter, Single year, Range of months, Range of dates, Compare two date ranges, Compare two months, Compare two quarters, and Compare two years.

A Departure Time drop down dialog box 1166 receives selection data from the user, wherein the received data selection is used by the system to filter in accordance with the selected departure time. A window in 24-hour format is selected to include flights departing between those times. Early morning business flyers may be segregated from the data set, for example, by setting the departure time range to 05:00-08:00. Alternatively, all flights may be included in the results by selecting a full 24 hours. As illustrated in the example embodiment, the flight departure time range is selected as: 00:00-23:00 to 00:00-23:00, and causes report to return records in which travel took place at a certain time of day.

A Fare Basis Codes drop down dialog box 1168 receives selection data from the user, wherein the received data selection is used by the system to filter fare basis codes by whether they start with a portion (start with), end with a portion (ends with), contain a portion (contain), or are exactly the same as a portion (equal). List may be entered, separated by commas, and blank fields maybe used to reveal information for all tickets, for example. The data field selections in the drop down box 1168 include, for example: Contains, Starts with, Ends with, and Equals.

Lastly with reference to FIG. 11a, a Trip RBKD(s) Filter drop down dialog box 1170 receives selection data from the user, wherein the received data selection is used by the system to search results by Revenue Booking Designators. One or more RBKD are selected (multi-select by holding the Control key down) to return only the data for specified revenue booking designators. Alternatively, choose All Designators to widen the scope to all revenue booking designators. The data field selections in the drop down box 1170 include, for example: A-Z.

In accordance with the example embodiment, a selection of the Run Report user interface button the internal database 125 is queried as shown at 1206 in FIG. 120 and a dynamic Traveler Report 1112 is generated as shown at 1208 as shown best in FIG. 11b. With reference now to that dynamic user interface 1112, as shown in the example, data is presented relating to all travelers from the origin airport 1174 to the destination airport 1175 based on the parameters received from the user at 1204 using the interface of FIG. 11a. Fields for Fare Basis Code 1176 and Journey RBKD 1177 are represented in the interface 1112 of the example embodiment. Fare basis codes are internal codes used by airlines to designate features of fares for selected flights.

With continued reference to the interface 1112, a convenient tool for analyzing the frequent flier data is provided in the Journey Miles 1178 and Frequent Flier Miles 1179 columns. For example, a first set of particular passengers 1171 received 4,846 frequent flier miles for a trip that extended for only 2,423 miles (i.e., 2 frequent fliers times trip distance of 2,423 equals 4,846 frequent flier miles awarded). Further, a second set of particular passengers 1172 received 4,798 frequent flier miles for a trip that extended for only 2,339 miles (i.e., 2 frequent fliers times trip distance of 2,399 equals 4,798 frequent flier miles awarded). These represent two different types of travel in the same market.

With continued reference to the interface 1112, a further convenient tool for analyzing the frequent flier data is provided in the Journey Fare 1182, the Journey Gross Fare 1183, Journey Revenue 1184, and Journey Gross Revenue 1185. For example, the airline received, from the first set of particular passengers 1171, a Journey Fare 1182 of $173.00, a Journey Gross Fare 1183 of $207.00, a Journey Revenue 1184 of $345.00, and a Journey Gross Revenue 1185 of $413.00. In contrast, the airline received, from the second set of particular passengers 1172, a Journey Fare 1182 of $159.00, a Journey Gross Fare 1183 of $193.00, a Journey Revenue 1184 of $319.00, and a Journey Gross Revenue 1185 of $385.00. Using this convenient tool of the interface 1112 enables user analysts to observe characteristics of travel group segments, particularly frequent fliers.

It is to be appreciated that the Pax column 1181 contains live dynamic links to presentation of further detail provided in a Detail Ticker Drill-Down report interface 1114 shown best in FIG. 11c. The Detail Ticker Drill-Down report interface 1114 presents actual travel data relative to the ticket data provided in the dynamic Traveler Report 1112 interface. Accordingly, in accordance with the example embodiment, based on the PNR records, purchase data may be compared or otherwise analyzed relative to actual travel performance data. This unique ability in accordance with the example embodiment provides numerous advantages to analysts heretofore unavailable.

In the example embodiment, selection of a report field of one of the dynamic links contained in the dynamic Traveler Report 1112 interface as shown at 1210 causes the system 100 to generate as shown at 1212 a travel data detailed report 1114 as illustrated. As shown there, the ticket purchase data indicates that a first traveler 1190 purchased tickets on Aug. 12, 2009 (1192) for a flight scheduled to depart on Oct. 13, 2009 (1193). Further as shown there, the performance data indicates that the first traveler boarded on a first leg 1194 and on a second leg 1195. Accordingly, the interface 1114 enables a side-by-side comparison between the purchase data and the performance data based on PNR records.

Also as shown in FIG. 11c, the ticket purchase data indicates that a second traveler 1191 purchased tickets on Aug. 12, 2009 (1192) for a flight scheduled to depart on Oct. 13, 2009 (1193). Further as shown there, the performance data indicates that the second traveler boarded on a first leg 1194 and on a second leg 1195. An analysis might conclude, among other things, that the passengers 1190, 1191 did not travel together.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications, and variations that fall within the spirit and scope of the appended claims, interpreted in accordance with the breadth to which they are fairly, legally, and equitably entitled.

We claim:

1. A user interface method by a computer executing one or more operations for presenting data in a visual dashboard display having plural dashboard panes for interfacing an associated user with a plurality of associated databases, the method comprising:
displaying, in a first visual pane of a user interface, a representation of a first set of query results retrieved from the plurality of associated databases in accordance with a first query;
displaying, in a second visual pane of the user interface, a representation of a second set of query results retrieved from the plurality of associated databases in accordance with a second query using the first set of query results as parameters of the second query;
displaying, in a third visual pane of the user interface, a representation of a third set of query results retrieved from the plurality of associated databases in accordance with a third query using at least one of the first set of query results or the second set of query results as parameters of the third query;
displaying, in a fourth visual pane of the user interface, a representation of a fourth set of query results retrieved from the plurality of associated databases in accordance with a fourth query using at least one of the first set of query results, the second set of query results or the third set of query results as parameters of the fourth query;
receiving user input making a selection relative to the representations in the first visual map pane of the first set of query results; and,
simultaneously updating, based on the selection of the user input, each of the representations in the first visual pane, the second visual pane, the third visual pane, and the fourth visual pane.

2. The method according to claim 1, wherein:
the displaying the representation of the first set of query results in the first visual pane comprises displaying, in a visual map pane of a user interface, a representation of a first set of travel origination locations retrieved from the plurality of associated databases, and a first set of travel destination locations retrieved from the plurality of associated databases;
the displaying the representation of the second set of query results in the second visual pane comprises displaying, in a passengers carried pane of the user interface, a representation of a set of quantities of passengers carried during a selected focus time period from selected ones of the first set of travel origination locations to selected ones of the first set of travel destination locations;
the displaying the representation of the third set of query results in the third visual pane comprises displaying, in a fare paid pane of the user interface, a representation of a set of fares paid by the passengers carried during the selected focus time period from the selected ones of the first set of travel origination locations to the selected ones of the first set of travel destination locations;
the displaying the representation of the fourth set of query results in the fourth visual pane comprises displaying, in a revenue pane of the user interface, a representation of revenues collected for travel during a selected gross time period from the selected ones of the first set of travel origination locations to the selected ones of the first set of travel destination locations, wherein at least a portion of the graphical representation of revenues comprises a product of the set of quantities of passengers and the set of fares paid by the passengers during the selected focus time period;
the receiving user input comprises receiving user input making a selection relative to the representations in the visual map pane of the first sets of travel origination and destination locations; and,
the simultaneously updating the first, second, third, and fourth visual panes comprises simultaneously updating, based on the selection of the user input, each of the representations in the visual map pane, the passengers serviced pane, the fare paid pane, and the revenue pane.

3. The method according to claim 2, wherein:
the displaying the representation of the first set of travel origination locations retrieved from the plurality of associated databases and the first set of travel destination locations retrieved from the plurality of associated databases comprises displaying in the visual map pane of the user interface a pictorial map representation of the first set of travel origination locations and the first set of travel destination locations;
the displaying the representation of the set of quantities of passengers carried during the selected focus time period comprises displaying in the passengers serviced pane of the user interface, a graphical representation of the set of quantities of passengers carried during the selected focus time period;
the displaying the representation of the set of fares paid by the passengers carried during the selected focus time period comprises displaying in the fare paid pane of the user interface, a graphical representation of the set of fares paid by the passengers carried during the selected focus time period; and,
the displaying the representation of revenues collected for travel during the selected gross time period comprises displaying in the revenue pane of the user interface a graphical representation of revenues collected for travel during the selected gross time period.

4. The method according to claim 3, wherein:
the receiving the user input comprises receiving user input selecting a second set of travel origination locations; and,
the simultaneously updating comprises simultaneously updating each of the representations in the visual map pane, the passengers serviced pane, the fare paid pane, and the revenue pane by:
displaying, in the passengers serviced pane of the user interface, a representation of a set of quantities of passengers carried during a selected focus time period from the second set of travel origination locations to the selected ones of the first set of travel destination locations;
displaying, in the fare paid pane of the user interface, a representation of a set of fares paid by the passengers carried during the selected focus time period from the second set of travel origination locations to the selected ones of the first set of travel destination locations; and,
displaying, in the revenue pane of the user interface, a representation of revenues collected for travel during a selected gross time period from the second set of travel origination locations to the selected ones of the first set of travel destination locations, wherein at least a portion of the graphical representation revenues comprises a product of the set of quantities of passengers and the set of fares paid by the passengers during the selected focus time period.

5. The method according to claim 4, wherein the receiving the user input comprises receiving a selection from the user of a first portion of the pictorial map representation in the visual map pane.

6. The method according to claim 5, further comprising:
receiving second user input selecting a second set of travel destination locations; and,
the simultaneously updating comprises simultaneously updating each of the representations in the visual map pane, the passengers serviced pane, the fare paid pane, and the revenue pane by:
displaying, in the passengers serviced pane of the user interface, a representation of a set of quantities of passengers carried during a selected focus time period from the second set of travel origination locations to the second set of travel destination locations;
displaying, in the fare paid pane of the user interface, a representation of a set of fares paid by the passengers carried during the selected focus time period from the second set of travel origination locations to the second set of travel destination locations; and,
displaying, in the revenue pane of the user interface, a representation of revenues collected for travel during a selected gross time period from the second set of travel origination locations to the second set of travel destination locations, wherein at least a portion of the graphical representation revenues comprises a product of the set of quantities of passengers and the set of fares paid by the passengers during the selected focus time period.

7. The method according to claim 6, wherein the receiving the second user input comprises receiving a selection from the user of a second portion of the pictorial map representation in the visual map pane.

8. The method according to claim 3, further comprising:
receiving second user input selecting a second set of travel destination locations; and,
the simultaneously updating comprises simultaneously updating each of the representations in the visual map pane, the passengers serviced pane, the fare paid pane, and the revenue pane by:
displaying, in the passengers serviced pane of the user interface, a representation of a set of quantities of passengers carried during a selected focus time period from the selected ones of the first set of travel origination locations to the second set of travel destination locations;
displaying, in the fare paid pane of the user interface, a representation of a set of fares paid by the passengers carried during the selected focus time period from the selected ones of the first set of travel origination locations to the second set of travel destination locations; and,
displaying, in the revenue pane of the user interface, a representation of revenues collected for travel during a selected gross time period from the selected ones of the first set of travel origination locations to the second set of travel destination locations, wherein at least a portion of the graphical representation revenues comprises a product of the set of quantities of passengers and the set of fares paid by the passengers during the selected focus time period.

9. The method according to claim 8, wherein the receiving the second user input comprises receiving a selection from the user of a second portion of the pictorial map representation in the visual map pane.

10. A user interface method by a computer system including a processor executing one or more instructions for presenting data in a visual dashboard display having plural user-selectable graphical dashboard panes for interfacing an associated user with an associated database, the method comprising:
receiving a first query selection signal;
executing a first query to selectively retrieve first result data from the associated database in accordance with the first query selection signal;
receiving a first query result presentation signal including data specifying a first graphical presentation style;
generating a display signal for displaying the first result data in the first graphical presentation style in accordance with the first query result presentation signal;
receiving a second query selection signal;
executing a second query to selectively retrieve second result data from the associated database in accordance with the second query selection signal;
receiving a second query result presentation signal including data specifying a second graphical presentation style; and,
generating a display signal for displaying the second result data in the second graphical presentation style in accordance with the second query result presentation signal.

11. The user interface method according to claim 10, wherein:
the receiving the first query result presentation signal includes receiving data specifying a first graphical presentation style comprising at least one of a graphical map, a graphical heat map, a graphical chart, a bar graph, a standard chart, a line chart, a line and bar chart, a pie chart, a bubble chart, a plot chart, a stacked bar chart, a histogram chart, an area chart, a point heat map, and a chart map;
the generating the display signal for displaying the first result data includes generating the display signal for displaying the first result data as at least one of the graphical map, the graphical heat map, the graphical chart, the bar graph, the standard chart, the line chart, the line and bar chart, the pie chart, the bubble chart, the plot chart, the stacked bar chart, the histogram chart, the area chart, the point heat map, and the chart map;
the receiving the second query result presentation signal includes receiving data specifying a second graphical presentation style comprising at least one of a graphical map, a graphical heat map, a graphical chart, a bar graph, a standard chart, a line chart, a line and bar chart, a pie chart, a bubble chart, a plot chart, a stacked bar chart, a histogram chart, an area chart, a point heat map, and a chart map; and,
the generating the display signal for displaying the second result data includes generating the display signal for displaying the second result data as at least one of the graphical map, the graphical heat map, the graphical chart, the bar graph, the standard chart, the line chart, the line and bar chart, the pie chart, the bubble chart, the plot chart, the stacked bar chart, the histogram chart, the area chart, the point heat map, and the chart map.

12. The user interface method according to claim 10, further comprising:
storing the first and second query selection signals in a memory of the computer system; and,
storing the first and second query result presentation signals in the memory of the computer system.

13. The user interface method according to claim 12, further comprising:
retrieving the first query selection signal from the memory;
executing the first query to selectively retrieve first result data from the associated database in accordance with the first query selection signal retrieved from the memory;
retrieving the first query result presentation signal from the memory;
generating a display signal for displaying the first result data in the first graphical presentation style in accordance with the first query result presentation signal retrieved from the memory;
retrieving the second query selection signal from the memory;
executing the second query to selectively retrieve second result data from the associated database in accordance with the second query selection signal retrieved from the memory;
retrieving the second query result presentation signal from the memory; and,
generating a display signal for displaying the second result data in the second graphical presentation style in accordance with the second query result presentation signal retrieved from the memory.

14. The user interface method according to claim 10, further comprising:
receiving a third query selection signal logically related to the first and second query selection signals;
executing a third query to selectively retrieve third result data from the associated database in accordance with the third query selection signal; and,
modifying the display signal for displaying the first result data in the first graphical presentation style in accordance with the first and third query result presentation signals.

15. The user interface method according to claim 14, further comprising:
modifying the display signal for displaying the second result data in the second graphical presentation style in accordance with the second and third query result presentation signals.

16. A user interface method by a computer executing one or more operations for presenting data to an associated user from a first database and a second database in selectable merged visual formats, the method comprising:
displaying, in a query parameter input section of a user interface, a dialog box configured to receive, from the associated user a first input query parameter;
receiving, at the query parameter input section, the first input query parameter from the associated user;
querying the associated first database in accordance with the first input query parameter to retrieve a first set of data;
querying the associated second database in accordance with the first input query parameter to retrieve a second set of data;
merging the first set of data with the second set of data as query result data, wherein the query result data comprises data from the first database and data from the second database; and
displaying a first selected portion of the query result data in a report display section of the user interface.

17. The method according to claim 16, wherein:
the first database is a firewall protected database;
the second database is a non-firewall protected database;
the first set of data is proprietary non-published data;
the second set of data is non-proprietary published data;
the query result data includes at least one proprietary non-published data and at least one non-proprietary published data.

18. The method according to claim 17, wherein:
the querying the associated firewall protected database comprises querying the associated firewall protected database by a protected associated local area network (LAN) in operative communication with the computer in accordance with the first input query parameter; and,
the querying the associated non-firewall protected database comprises querying the associated non-firewall protected database by a non-protected associated wide area network (WAN) in operative communication with the computer in accordance with the first input query parameter.

19. The method according to claim 18, further comprising:
receiving from the associated user a selection of a one of the query result data;
identifying a second portion of the query result data used to generate the selected one of the query result data; and,
displaying the second portion of the query result data in the report display section of the user interface.

20. The method according to claim 19, wherein:
the displaying the second portion of the query result data comprises replacing the first selected portion of the query result data with the second portion of the query result data in the report display section of the user interface.

21. A user interface method by a computer executing one or more operations for presenting detailed drill down data to an associated user from at least one associated database for comparison of first data with second data, the method comprising:
displaying, in a query data parameter portion of a user interface, a representation of a first set of query parameters;
receiving from the associated user a selection of a first set of query parameter selections;
generating a query based on the selected first set of query parameter selections;
retrieving first data from the associated database in accordance with the first query;
displaying a first portion of the first data as first level results in a first level result presentation portion of the user interface;
receiving from the associated user a drill-down selection of a one of the first level results;
retrieving second data from the associated database in accordance with the drill-down selection, wherein the second data comprises underlying data forming the first data; and,
displaying the second portion of the first data as second level results in a second level result presentation portion of the user interface wherein first data is displayed adjacent second data.

22. The method according to claim 21, wherein:
the displaying the representation of the first set of query parameters comprises displaying, in the query data parameter portion of the user interface, a representation of a first set of travel origination regions and a representation of a first set of travel destination regions, a representation of a first travel ticket purchase period, and a representation of a first travel period;
the receiving the selection of the first set of query parameter selections comprises:
receiving from the associated user a selection of a first travel origination from among the first set of travel origination regions;
receiving from the associated user a selection of a first travel destination from among the first set of travel destination regions;
receiving from the associated user a selection of a first travel ticket purchase period; and,
receiving from the associated user a selection of a first travel period;
the generating the query comprises generating the query based on the selected first travel origination, the selected first travel destination, the selected ticket purchase period, and the selected first travel period;
the retrieving the first data comprises retrieving first ticket purchase data from the associated database in accordance with the query;
the displaying comprises displaying a first portion of the first ticker purchase data as first level ticket purchase results in a first level result presentation portion of the user interface;
the receiving the drill-down selection comprises receiving from the associated user a drill-down selection of a one of the first level ticket purchase results;
the retrieving the second data comprises retrieving first travel data from the associated database in accordance with the drill-down selection; and,
the displaying the second portion comprises displaying the second portion of the first data as second level results in a second level result presentation portion of the user interface wherein ticket purchase data is displayed adjacent travel performance data for selected one or more travelers.

23. The method according to claim 22 wherein:
the retrieving the first ticket purchase data from the associated database comprises retrieving first ticket purchase price data from the associated database in accordance with the query;
the displaying the first portion of the first ticket purchase data comprises displaying the first ticket purchase price data as the first level ticket purchase results in the first level result presentation portion of the user interface.

24. The method according to claim 22, wherein:
the displaying the second portion of the first data comprises displaying travel performance data over one or more travel legs for the selected one or more travelers.

25. The method according to claim 22, wherein:
the displaying the second portion of the first data comprises displaying travel date performance data over one or more travel legs for the selected one or more travelers.
